(19) United States
(12) Patent Application Publication
(10) Pub. No.: US 2024/0083067 A1
(43) Pub. Date: Mar. 14, 2024

(54) WASTE-FREE PROCESSING FOR LIGNIN MODIFICATION OF FIBROUS PLANT MATERIALS, AND LIGNIN-MODIFIED FIBROUS PLANT MATERIALS

(71) Applicant: UNIVERSITY OF MARYLAND, COLLEGE PARK, College, MD (US)

(72) Inventors: Liangbing HU, Rockville, MD (US); Yu LIU, Berwyn Heights, MD (US)

(21) Appl. No.: 18/274,393

(22) PCT Filed: Aug. 27, 2022
(86) PCT No.: PCT/US22/41779

§ 371 Date: Jul. 26, 2023

Related U.S. Application Data
(60) Provisional application No. 63/237,625, filed on Aug. 27, 2021.

(51) Int. Cl. B27K 3/20; B27K 3/08

(52) U.S. Cl. CPC B27K 3/20; B27K 3/08

(57) ABSTRACT

A piece of natural fibrous plant material, such as wood or bamboo, can be infiltrated with a chemical solution and subsequently subjected to a temperature of at least 80° C. to produce a softened piece of fibrous plant material having modified lignin therein. The content of modified lignin in the softened piece can be at least 90% of the content of native lignin in the natural fibrous plant material. The modified lignin retained in the softened piece can have shorter macromolecular chains than that of the native lignin. The softened piece can be subjected to densification, for example, to yield a high-strength structural material, or to subsequent drying, for example, to yield a flexible or anisotropically-clastic material. The processing of the natural fibrous plant material can avoid, or at least reduce, the production of black liquor or other waste liquids.

### CROSS-REFERENCE TO RELATED APPLICATION(S)

The present application claims the benefit of U.S. Provisional Application No. 63/237,625, filed Aug. 27, 2021, entitled “Waste-Free Processing for Lignin Modification of Fibrous Plant Materials, and Lignin-Modified Fibrous Plant Materials,” which is incorporated by reference herein in its entirety.

### STATEMENT REGARDING FEDERALLY SPONSORED RESEARCH

This invention was made with government support under DEAR0001025 awarded by the U.S. Department of Energy, Advanced Research Projects Agency-Energy (ARPA-E). The government has certain rights in the invention.

### FIELD

The present disclosure relates generally to processing of fibrous plant materials, and more particularly, to waste-free (or at least waste-reduced) processing for modifying native lignin in fibrous plant materials and products resulting therefrom.

### BACKGROUND

Fibrous plant materials hold the potential to replace a broad range of non-renewable and/or petroleum-based products toward a sustainable society. Recent progress on processing natural wood into high performance, low cost and sustainable structural materials opens up a promising route to replace existing structural materials (e.g., steel and other alloys) that are widely used in construction, automotive and aerospace industries. For example, densified wood prepared by partially removing lignin and hemicellulose from natural wood followed by densification exhibits a strength of 580 MPa. Nanocellulose films have also been fabricated with a strength up to 1 GPa by removing 90% of lignin, while keeping the high degree of polymerization of cellulose. However, in conventional lignin-removal techniques, the delignification process consumes a relatively large quantity of chemicals and produces a relatively large quantity of liquid waste, causing additional operating cost, energy consumption, and environmental concerns. Embodiments of the disclosed subject matter may address one or more of the above-noted problems and disadvantages, among other things.

### SUMMARY

Embodiments of the disclosed subject matter provide lignin-modified fibrous plant materials and substantially waste-free processing for lignin modification of fibrous plant materials. In some embodiments, a natural fibrous plant material (e.g., wood, bamboo, etc.) can be infiltrated or infused with one or more chemicals, for example, via native channels of the natural plant microstructure (e.g., lumina formed by cellulose-based walls of longitudinal cells of the fibrous plant material). The chemical-infiltrated plant material can then be heated to yield a softened plant material, which retains the cellulose-based microstructure of the natural plant material as well as most or substantially all lignin that was present in the starting material. In some embodiments, the retained lignin can be modified, for example, having shortened macromolecular chains as compared to native lignin.

In some embodiments, the process can produce no or minimal liquid waste (e.g., black liquor). Rather, depolymerized fragments of lignin and/or hemicellulose can be immobilized within the microstructure of the softened plant material. In some embodiments, most or substantially all of the chemicals used to produce the modification can be reacted with lignin and hemicellulose during the heating, for example, to generate a softened plant material with a neutral pH. In some embodiments, the softened plant material can be subject to densification (e.g., via pressing) and/or drying to yield a structural material with desired mechanical properties (e.g., increased strength, increased flexibility, anisotropic elasticity, etc.). In some embodiments, any fluid produced by the processing (e.g., fluid squeezed out during densification and/or evaporated fluid or vapor escaping during drying) can be substantially-free of any chemicals used to produce the modification and/or salts resulting therefrom.

In one or more embodiments, a method can comprise infiltrating a piece of natural fibrous plant material with one or more chemical solutions. The method can further comprise after the infiltrating, subjecting the piece of natural fibrous plant material with the one or more chemical solutions therein to a first temperature of at least 80° C. for a first time so as to produce a softened piece of fibrous plant material. A content of modified lignin in the softened piece can be at least 90% of a content of native lignin in the piece of natural fibrous plant material. The modified lignin retained in the softened piece can have shorter macromolecular chains than that of the native lignin in the fibrous plant material.

In one or more embodiments, a structure can comprise a densified piece of fibrous plant material. The densified piece of fibrous plant material can have a density of at least 1.0 g/cm³ and modified lignin therein. The modified lignin can have shorter macromolecular chains than that of native lignin in natural fibrous plant material.

In one or more embodiments, a structure can comprise a dried piece of fibrous plant material. The dried piece of fibrous plant material can have modified lignin therein and can retain open lumina of a native microstructure of natural fibrous plant material. The modified lignin can have shorter macromolecular chains than that of native lignin in the natural fibrous plant material.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1 is a simplified schematic diagram of lignin modification of natural fibrous plant material, according to one or more embodiments of the disclosed subject matter.

FIG. 2A illustrates radial, longitudinal, and rotary cut pieces of natural wood, as well as a cross-section in the radial-tangential plane of natural wood, which may be subjected to in situ lignin modification, according to one or more embodiments of the disclosed subject matter.

FIG. 2B illustrates a simplified partial cut-away view a of a natural bamboo segment that may be subjected to in situ lignin modification, according to one or more embodiments of the disclosed subject matter.

FIG. 2C shows a magnified image (top) of the culm of the natural bamboo segment of FIG. 2B and a further magnified image (bottom) showing the hierarchical microstructure of the culm wall.

FIGS. 3A-3C show exemplary reactions for in situ modification of native lignin, native hemicellulose, and native cellulose in a fibrous plant material, respectively, according to one or more embodiments of the disclosed subject matter.

FIG. 4A is a simplified process flow diagram of a generalized method of substantially waste-free processing for lignin modification of fibrous plant materials, according to one or more embodiments of the disclosed subject matter.

FIG. 4B is a simplified process flow diagram of a method for densifying lignin-modified fibrous plant materials, according to one or more embodiments of the disclosed subject matter.

FIG. 4C is a simplified process flow diagram of a method for molding lignin-modified fibrous plant materials, according to one or more embodiments of the disclosed subject matter.

FIG. 4D is a simplified process flow diagram of a method for forming lignin-modified fibrous plant materials into a flexible or anisotropically-elastic structure, according to one or more embodiments of the disclosed subject matter.

FIG. 4E is a simplified process flow diagram of a method for self-densifying lignin-modified fibrous plant materials, according to one or more embodiments of the disclosed subject matter.

FIGS. 5A-5C are simplified schematic diagrams of various heating configurations for activating infiltrated chemicals in a fibrous plant material to form a lignin-modified fibrous plant material, according to one or more embodiments of the disclosed subject matter.

FIG. 6A is a graph of measured composition of natural wood and softened wood with in situ lignin modification, according to one or more embodiments of the disclosed subject matter.

FIG. 6B is a graph of measured moisture contents for natural wood, chemically-infiltrated wood, softened wood with in situ lignin modification, and densified wood with in situ lignin modification, according to one or more embodiments of the disclosed subject matter.

FIG. 6C is a graph of stress versus strain for natural wood and densified wood with in situ lignin modification, according to one or more embodiments of the disclosed subject matter.

FIG. 7A is a graph comparing measured reflectance data for densified, partially-delignified wood and densified wood with in situ lignin modification, according to one or more embodiments of the disclosed subject matter.

FIG. 7B is a graph comparing measured ash content for densified, partially-delignified wood and densified wood with in situ lignin modification, according to one or more embodiments of the disclosed subject matter.

FIG. 7C is a graph comparing measured hot water extract for densified, partially-delignified wood and densified wood with in situ lignin modification, according to one or more embodiments of the disclosed subject matter.

FIGS. 7D-7E are graphs obtained via electrospray ionization mass spectrometry (ESI-MS) of hot water extract solutions obtained from densified wood with in situ lignin modification and densified, partially, delignified wood, respectively, according to one or more embodiments of the disclosed subject matter.

FIG. 8 is a graph of measured moisture contents for chemically-infiltrated wood, softened wood with in situ lignin modification, pre-dried softened wood with in situ lignin modification, and densified wood with in situ lignin modification, according to one or more embodiments of the disclosed subject matter.

FIG. 9 is a graph of stress versus strain for densified bamboo with in situ lignin modification, according to one or more embodiments of the disclosed subject matter.

FIG. 10 is a graph of stress versus strain for self-densified wood with in situ lignin modification, according to one or more embodiments of the disclosed subject matter.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Fibrous plant material: A portion (e.g., a cut portion, via mechanical means or otherwise) of any photosynthetic eukaryote of the kingdom Plantae in its native state as grown. In some embodiments, the fibrous plant material comprises wood (e.g., hardwood or softwood), bamboo (e.g., any of Bambusoideae, such as but not limited to Moso, Phyllostachys vivax, Phyllostachys viridis, Phyllostachys bambusoides, and Phyllostachys nigra), reed (e.g., any of common reed (Phragmites australis), giant reed (Arundo donax), Burma reed (Neyraudia reynaudiana), reed canary-grass (Phalaris arundinacea), reed sweet-grass (Glyceria maxima), small-reed (Calamagrostis species), paper reed (Cyperus papyrus), bur-reed (Sparganium species), reed-mace (Typha species), cape thatching reed (Elegia tectorum), thatching reed (Thamnochortus insignis), or grass (e.g., a species selected from the Poales order or the Poaceae family). For example, the wood can be any type of hardwood or softwood, such as, but not limited to, basswood, oak, poplar, ash, alder, aspen, balsa wood, beech, birch, cherry, butternut, chestnut, cocobolo, elm, hickory, maple, oak, padauk, plum, walnut, willow, yellow poplar, bald cypress, cedar, cypress, douglas fir, fir, hemlock, larch, pine, redwood, spruce, tamarack, juniper, and yew. Alternatively or additionally, in some embodiments, the plant material can be any type of fibrous plant composed of lignin, hemicellulose, and cellulose. For example, the plant material can be bagasse (e.g. formed from processed remains of sugarcane or sorghum stalks) or straw (e.g., formed from processed remains of cereal plants, such as rice, wheat, millet, or maize).

Contiguous piece: A single continuous piece of fibrous plant material (e.g., a continuous piece of wood taken from a single tree) and subject to processing, as contrasted with a single piece formed by joining or layering multiple subpieces (e.g., laminate). In some embodiments, the contiguous piece consists essentially of the fibrous plant material (e.g., formed from the single continuous piece of plant material, but optionally including a surface coating or additives, for example, to improve weatherability or provide hydrophobicity).

Lignin characteristics: In some embodiments, lignin characteristics refers to characteristics (e.g., content) of a naturally-occurring or native form of lignin in the fibrous plant material. Modified lignin characteristics can thus refer to characteristics of lignin in a section of fibrous plant material that has been in situ modified (e.g., by chemical reaction with OH⁻) to depolymerize lignin, with the depolymerized lignin being retained within the plant material. In some embodiments, the lignin content within the modified plant material (e.g., softened plant material) can be at least 90% (e.g., ≥95%) of the lignin content prior to said modification. Lignin content within the fibrous plant material before and after lignin modification can be assessed using known techniques in the art, for example, Laboratory Analytical Procedure (LAP) TP-510-42618 for “Determination of Structural Carbohydrates and Lignin in Biomass,” Version 08-03-2012, published by National Renewable Energy Laboratory (NREL), ASTM E1758-01(2020) for “Standard Test Method for Determination of Carbohydrates in Biomass by High Performance Liquid Chromatography,” published by ASTM International, and/or Technical Association of Pulp and Paper Industry (TAPPI), Standard T 222-om-83, “Standard Test Method for Acid-Insoluble Lignin in Wood,” all of which are incorporated herein by reference.

Moisture content: The amount of fluid, typically water, retained within the microstructure of the plant material. In some embodiments, the moisture content (MC) can be determined by oven-dry testing, for example by calculating the change in weight achieved by oven drying (e.g., at 103° C. for 6 hours) the plant material, using the equation:

$$MC ( \% ) = \frac{weight before dry - weight after dry}{weight before dry} \times 100.$$

Alternatively or additionally, moisture content can be assessed using known techniques in the art, for example, an electrical moisture meter or other techniques disclosed in ASTM D4442-20 (2020) for “Standard Test Methods for Direct Moisture Content Measurement of Wood and Wood-based Materials,” published by ASTM International, which standard is incorporated herein by reference.

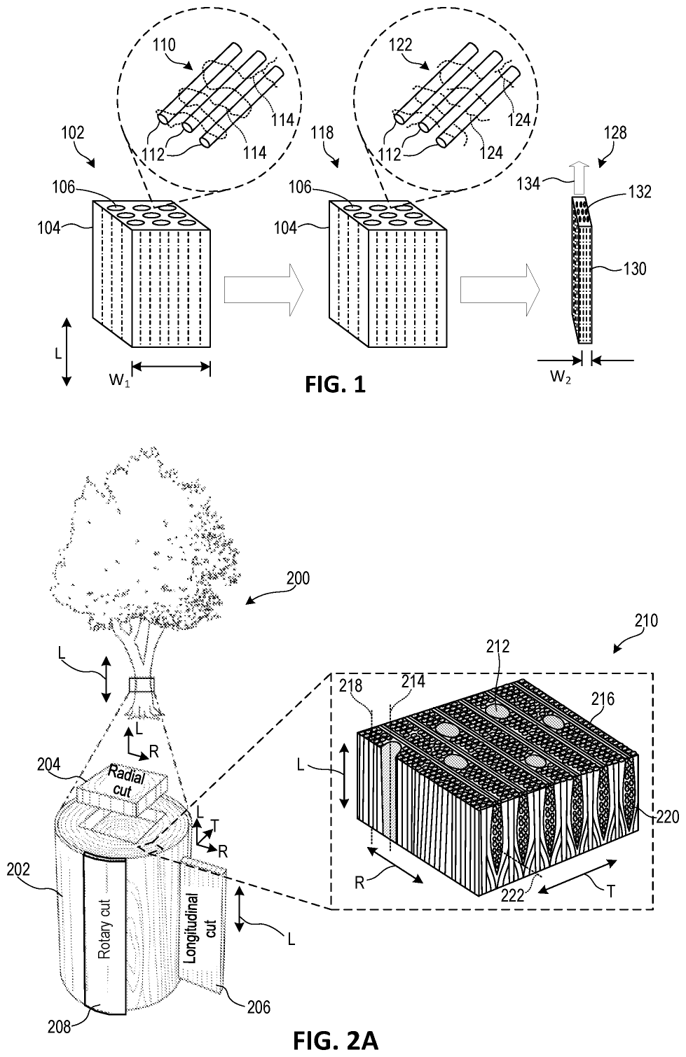

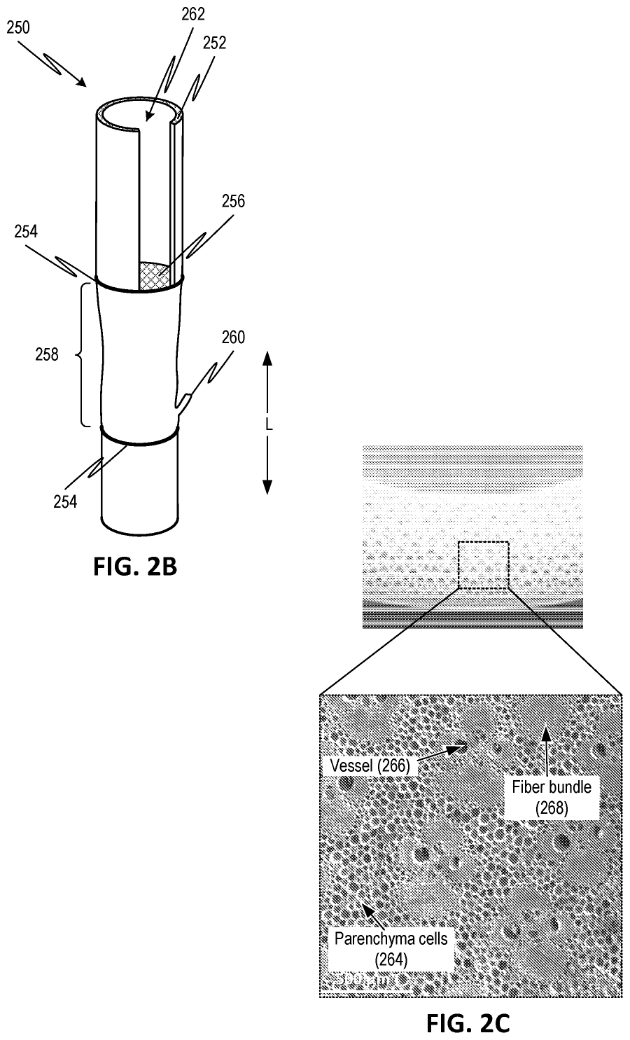

Longitudinal growth direction (L): A direction along which a plant (e.g., tree) grows from its roots or from a main body thereof (e.g., direction L for trunk 202 from tree 200 in FIG. 2A). Cellulose nanofibers forming cell walls of fiber cells, vessels, and/or tracheids of the fibrous plant material may generally be aligned with the longitudinal direction. In some cases, the longitudinal direction for the fibrous plant material may be generally vertical and/or correspond to a direction of the plant's water transpiration stream (e.g., from roots of the tree). The longitudinal direction can be perpendicular to the radial and tangential directions of the fibrous plant material.

Radial growth direction (R): A direction that extends from a center portion of the fibrous plant material outward (e.g., direction R for trunk 202 from tree 200 in FIG. 2A). In some embodiments, ray cells of the fibrous plant material (e.g., ray cells 220 for wood microstructure 210 in FIG. 2A) can extend along the radial direction. In some cases, the radial direction for the native fibrous plant material may be generally horizontal. The radial direction can be perpendicular to the longitudinal and tangential directions of the fibrous plant material.

Tangential growth direction (T) or circumferential direction: A direction perpendicular to both the longitudinal and radial directions in a particular cut of fibrous plant material (e.g., direction T for trunk 202 from tree 200 in FIG. 2A). In some cases, the tangential direction for the native fibrous plant material may be generally horizontal. In some embodiments, the tangential direction can follow a growth ring of the fibrous plant material.

Elasticity: Ability of modified plant material (consisting essentially of plant material, plant material with one or more coatings, or a composite of plant material filled with a polymer) to resist a compressive force and to return to its original shape and size when that force is removed. In some embodiments, modified plant material subjected to a microstructure-preserving drying process (e.g., freeze-drying, solvent exchange, and/or critical point drying) may be substantially elastic along the tangential direction only, while being substantially inelastic along the radial and longitudinal directions.

Black liquor: An aqueous solution of lignin residues, hemicellulose, and other inorganic chemicals employed in the processing of the natural plant material (e.g., modification of the lignin of the natural plant material to form a softened plant material).

Self-densification: Densification of a softened plant material that results from drying (e.g., air-drying) of the softened plant material, for example, from a moisture content greater than 30 wt % (e.g., 30-50 wt %, inclusive) to a moisture content less than 10 wt % (e.g., 3-8 wt %, inclusive). In some embodiments, the self-densification can be performed without any external pressing or with only minimal compression (e.g., less than or equal to 100 kPa). In some embodiments, the self-densification can be performed using a mold, clamp, or other structure designed to constrain a shape of the softened plant material as it dries, for example, to avoid, or at least reduce, any curving, bending, or other undesirable shape change of the plant material induced by the drying.

### INTRODUCTION

Embodiments of the disclosed subject matter provide methods for modification of lignin of natural fibrous plant materials, for example, to allow densification thereof, and structures formed from such lignin-modified fibrous plant materials. For example, during an infiltration stage 102 as shown in FIG. 1, a natural fibrous plant material 104 can be infiltrated or infused with one or more chemicals, for example, via the native lumina 106 formed by cellulose-based cell walls in the microstructure of the fibrous plant material. For example, the microstructure can have longitudinally-extending fiber cell walls formed of a composite 110 of cellulose fibrils 112 bonded together by hemicellulose and lignin adhesive matrix 114, which is strong and rigid.

Upon activation (e.g., via heating at an elevated temperature, such as 80-180° C.), the infiltrated chemicals can modify the native lignin in situ. For example, during an activation stage 118 as shown in FIG. 1, the macromolecular chains of the native lignin can be broken into smaller segments 124, thereby resulting in a more compliant composite 122 for the modified fibrous plant material while still retaining the cellulose-based lumina 106 of the native microstructure. As a result of the lignin-modified composite, the softened fibrous plant material can be more easily densified or otherwise subject to further processing (e.g., drying). In some embodiments, the pressing for densification may be along a direction substantially perpendicular at a longitudinal growth direction (L) of the fibrous plant material. For example, during a densification stage 128, the softened material can be compressed to form a densified material 130, with the previously-open cellulose-based lumina 106 now substantially collapsed as shown at 132 in FIG. 1. Alternatively, in some embodiments, the pressing for densification may be along a direction crossing the longitudinal growth direction or parallel to the longitudinal growth direction. Alternatively, in some embodiments, the densified material 130 can be formed via self-densification, for example, by drying in air without significant external compression.

In some embodiments, a width, W₁, of the natural fibrous plant material 104 can be at least 2 times (e.g., at least 3-5 times) a width, W₂, of the densified plant material 130. In addition, the densified plant material can have an increased density as compared to the natural fibrous plant material. For example, the densified plant material may have a density of at least 1.15 g/cm³ (e.g., at least 1.2 g/cm³, or at least 1.3 g/cm³), while the natural fibrous plant material may have a density less than 1.0 g/cm³ (e.g., less than 0.9 g/cm³, or less than 0.5 g/cm³).

In some embodiments, the infiltrated chemicals can comprise a chemical that produces hydroxide (OH⁻) ions in solution, for example, an alkaline chemical. Since long-term exposure of fibrous plant material to alkali can degrade the cellulose (which in turn can lead to a reduction in mechanical properties), the amount of chemicals infiltrated and/or the duration of the heating can be selected to ensure all of the alkaline chemicals within the fibrous plant material are completely reacted to obtain a neutral softened plant material. For example, after heating, some liquid 134 can be squeezed from the fibrous plant material 130 to measure the pH to determine whether the alkali has completely reacted. But such extruded liquid 134 (if any) mainly contains some inorganic salts as well as degradation products of cellulose and hemicellulose, but not black liquor. Alternatively, in some embodiments, the softened plant material can be subject to drying (e.g., air drying) after the activation stage 118 but prior to the densification stage 128, for example, to reduce a moisture content of the softened plant material and thereby avoid, minimize, or at least reduce, the production of liquid 134 during the pressing. Since excessive drying may result in a rigid or inflexible structure for the plant material that would be incompatible with densification, in some embodiments, the pre-drying can be effective to reduce a moisture content to greater than 10 wt %, for example, in a range of 10-20 wt %, inclusive (e.g., ˜15 wt %). In some embodiments, the plant material 130 after densification can have a moisture content less than 8-10 wt %, for example, in a range of 3-8 wt %, inclusive (e.g., 4-6 wt %, inclusive).

After pressing or when the fibrous plant material is otherwise subsequently dried after the chemical activation that produces the in situ lignin modification, the removal of water can immobilize the degradation products within the modified plant material. Since all (or at least most of) these substances are neutral, long-term exposure does not cause degradation of cellulose, thereby ensuring improved mechanical properties of the processed plant material. In conventional delignification, a washing step after chemical treatment is necessary, since the pH of the delignified plant material is generally higher than 13, and the delignified plant material has to be washed to achieve a neutral pH. This not only consume significant amounts of water (and thereby generates significant amounts of wastewater) but also requires substantial processing time (e.g., 72 hours to wash an 8″×4″×2.5″ block of wood). In contrast, embodiments of the disclosed subject matter avoid, or at least reduce, generation of wastewater by consuming the chemicals in the lignin modification of the fibrous plant material.

Since all chemicals are consumed to produce the in situ lignin modification, the resulting softened plant material can exhibit a neutral pH. Moreover, the production of black liquor and other wastewater can be avoided, minimized, or at least reduced as compared to conventional delignification processes. In addition, the products of degradation of the native hemicellulose and lignin are all immobilized inside the channels of the softened plant material. In other words, the processing via infiltrated alkaline chemical can modify the lignin and hemicellulose within the fibrous plant material, but without otherwise removing the lignin and hemicellulose from the fibrous plant material. As a result, the chemical content and composition of the processed plant material can be substantially the same as the starting natural plant material.

In some embodiments, the in situ lignin modification can result in a reduction in lignin content of the processed plant material by no more than 10%. For example, a content of modified lignin (e.g., on a wt % basis) in the processed plant material (e.g., softened plant material and/or densified plant material) can be at least 90% (e.g., at least 95%) of a content of the native lignin originally in the natural plant material. For example, after the in situ modification, the processed plant material can have a lignin content greater than or equal to 25 wt % for softwood, greater than or equal to 20 wt % for hardwood, or greater than or equal to 26 wt % for bamboo. Alternatively or additionally, in some embodiments, the in situ modification can result in a reduction in hemicellulose content of the processed plant material by no more than 10%. For example, a content of modified hemicellulose (e.g., on a wt % basis) in the processed plant material (e.g., softened plant material and/or densified plant material) can be at least 90% (e.g., at least 95%) of a content of the native hemicellulose originally in the natural plant material.

As noted above, in some embodiments, the natural fibrous plant material can be natural wood. Natural wood has a unique three-dimensional porous microstructure comprising and/or defined by various interconnected cells. For example, FIG. 2A illustrate a hardwood microstructure 210 where vessels 212 are disposed within a hexagonal array of wood fiber cells 216 in a longitudinally-extending cell region. The vessels and fibers cells can extend along longitudinal direction, L, of the wood. Thus, the lumen of each vessel 212 can have an extension axis 214 that is substantially parallel to the longitudinal direction, L, and the lumen of each fiber cell 216 can have an extension axis 218 that is substantially parallel to the longitudinal direction, L. Arranged between adjacent regions along tangential direction, T, is a radially-extending cell region, where a plurality of ray cells 220 are disposed. The ray cells 220 can extend along radial direction, R, of the wood. Thus, the lumen of each ray cell 220 can have an extension axis 222 that is substantially parallel to the radial direction, R, of the wood. An intracellular lamella is disposed between the vessels 212, fiber cells 216, and ray cells 220, and serves to interconnect the cells together. Softwoods can have a similar microstructure structure as that of hardwood, but with the vessels and wood fibers being replaced by tracheids that extend in the longitudinal direction, L, of the wood.

The cut direction of the original piece of wood can dictate the orientation of the cell lumina in the final structure. For example, in some embodiments, a piece of natural wood can be cut from a trunk 202 of tree 200 in a vertical or longitudinal direction (e.g., parallel to longitudinal wood growth direction, L) such that lumina of longitudinally-extending cells are oriented substantially parallel to a major face (e.g., largest surface area) of the longitudinal-cut wood piece 206. In the longitudinal-cut wood piece 206, the tangential direction, T, can be substantially perpendicular to the major face. Alternatively, in some embodiments, the piece of natural wood can be cut in a horizontal or radial direction (e.g., perpendicular to longitudinal wood growth direction, L) such that lumina of longitudinally-extending cells are oriented substantially perpendicular to the major face of the radial-cut wood piece 204. Alternatively, in some embodiments, the piece of natural wood can be cut in a rotation direction (e.g., perpendicular to the longitudinal wood growth direction L and along a circumferential direction of the trunk 202) such that lumina of longitudinal cells are oriented substantially parallel to the major face of the rotary-cut wood piece 208. In some embodiments, the piece of natural wood can be cut at any other orientation between longitudinal, radial, and rotary cuts. In some embodiments, the cut orientation of the wood piece may dictate certain mechanical properties of the final processed wood (e.g., a direction of elasticity only along a tangential direction in the final structure).

Alternatively, in some embodiments, the natural fibrous plant material can be natural bamboo. FIG. 2B shows a partial cutaway view of a bamboo segment 250 in its naturally-occurring state. The segment 250 has a culm wall 252 surrounding a hollow interior region 262, which is divided along a length of the culm wall 252 into internal nodal regions 258 by nodes 254 formed by an internal nodal diaphragm 256. The culm wall 252 has fibers extending along a longitudinal direction L (e.g., bamboo growth direction or a direction substantially parallel to an axis defined by the hollow interior region 262) of the bamboo segment 250) that are embedded in a lignin matrix. One or more branch stubs 260 can extend from a particular internal nodal region 258 and can serve as the root from which a culm wall for a new bamboo segment may grow (e.g., thus defining a different longitudinal direction for the new segment).

Within the culm wall 252, the bamboo exhibits a hierarchical cellular structure with porous cells that provide nutrient transport and dense cells that provide mechanical support. For example, FIG. 2C shows images of a cross-section of a bamboo segment 250, in particular, illustrating the microstructure of parenchyma cells 264, vessels 266, and fiber bundles 268 that constitute the culm wall 252. The fiber bundles 268 are highly aligned and extend substantially parallel to the longitudinal direction L whereas parenchyma cells 264 can be parallel or perpendicular to the longitudinal direction L. The density of the fiber bundles 268 can increase along the radial direction, such that an outer portion of the bamboo 250 closest to the exterior surface has different mechanical properties than an inner portion of the bamboo closest to the hollow interior region 262.

Each vessel 266 can define an open lumen that extends along the longitudinal direction L. Moreover, the elementary fibers that form the fiber bundles 268 may also have irregular small lumina in a center thereof. The fiber bundles 268, parenchyma cells 264, and vessels 266 adhere to each other via a polymer matrix composed of lignin and hemicellulose. The native microstructure can also exhibit pit apertures on the longitudinal walls of fibers, porosity introduced by the parenchyma cells, and/or open intercellular space between adjacent fibers. Embodiments of the disclosed subject matter can in situ modify this natural polymer matrix in order to soften the bamboo for densification and/or further processing.

### In Situ Modification

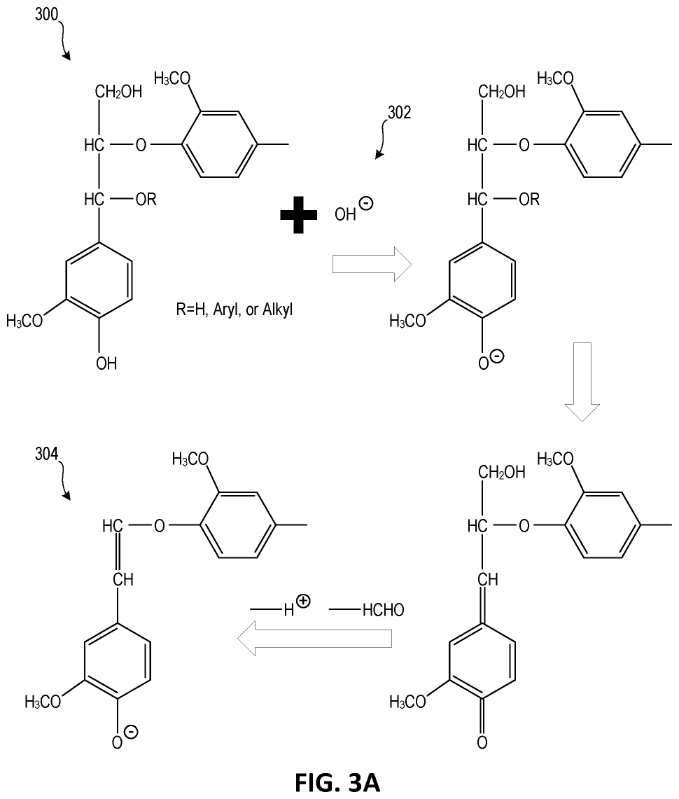

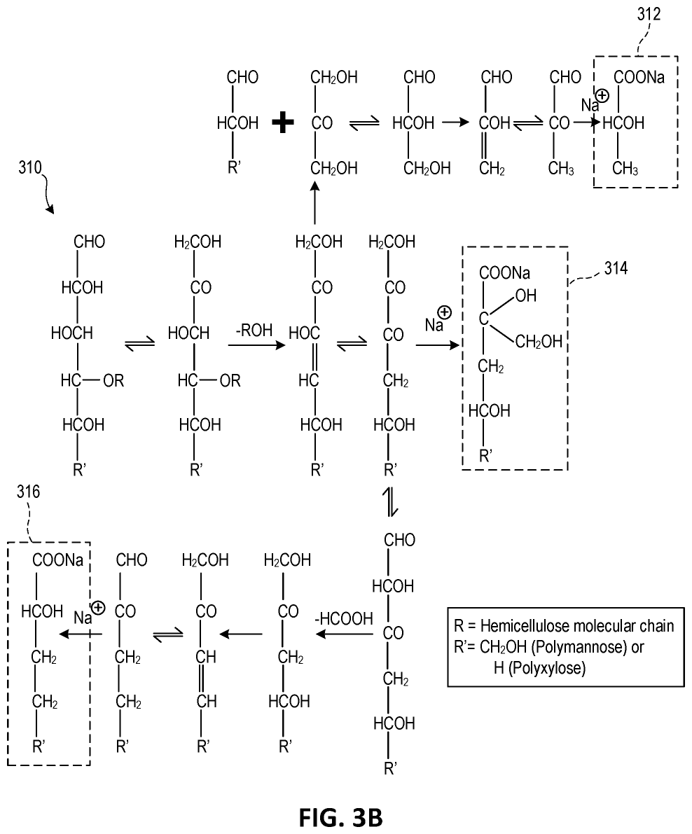

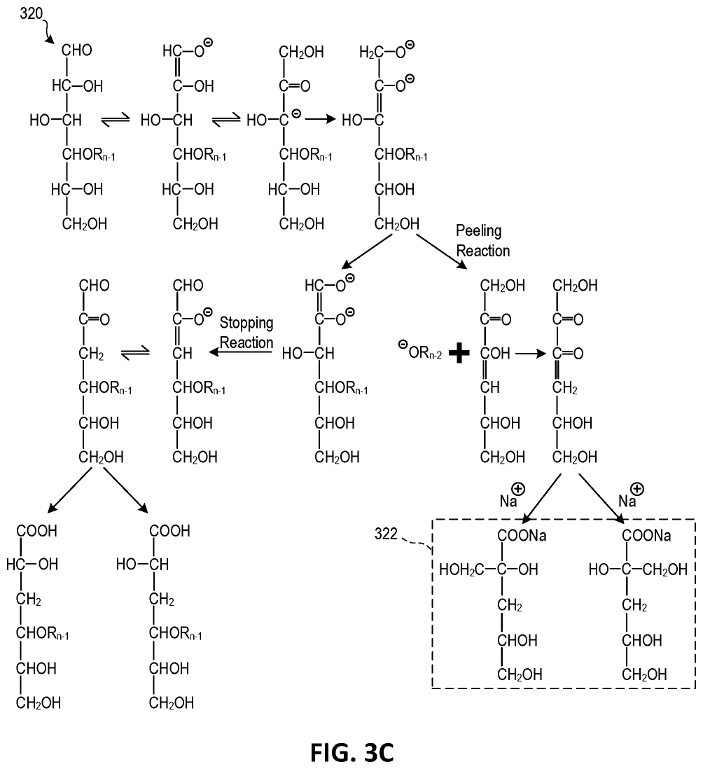

In some embodiments, the alkali chemical infiltrated into the fibrous plant material can react with the native lignin to cause modification thereof. For example, in some embodiments, the native lignin can be modified to break the lignin macromolecular chain into segments. As shown in FIG. 3A, OH⁻ ions 302 from the infiltrated alkali chemical (e.g., NaOH) can react with the phenolic hydroxyl group in lignin 300, and, at a same time, OH⁻ ions can also cause link bonds in the lignin macromolecules to break, thus shortening the lignin macromolecular chain. As a result of the modified lignin, the processed plant material is softened. In addition, the lignin degradation products 304 can react with the infiltrated alkali chemical (e.g., NaOH) to form a salt of phenol (e.g., a sodium salt of phenol).

Alternatively or additionally, in some embodiments, the alkali chemical infiltrated into the fibrous plant material can react with native hemicellulose to cause modification (e.g., degradation) thereof. For example, as shown in FIG. 3B, OH⁻ ions can cause degradation of hemicellulose 310 by peeling reaction, thereby producing acidic degradation products. These acidic products can react with the alkali chemical (e.g., NaOH) to form neutral salts that can be immobilized within the final processed plant material. For example, the hemicellulose degradation products can react with the infiltrated alkali chemical (e.g., NaOH) to form salts 312, 314, 316 of alduronic acid (e.g., sodium salts of alduronic acid).

Alternatively or additionally, in some embodiments, the alkali chemical infiltrated into the fibrous plant material can react with native cellulose to cause modification (e.g., degradation) thereof. For example, as shown in FIG. 3C, OH⁻ ions can cause degradation of cellulose 320 by peeling reaction. The degradation products can react with the alkali chemical (e.g., NaOH) to form neutral salts the can be immobilized within the final processed plant material. For example, the cellulose degradation products can react with the infiltrated alkali chemical (e.g., NaOH) to form salts 322 of gluconate (e.g., sodium salts of gluconate). The reducing end group in the cellulose chain can be prone to elimination under alkali condition, thereby exposing a new reducing group. The generation of new reductive ends can allow for repeated removal of reductive ends from the cellulose macromolecules. Accordingly, significant amounts of salt (e.g., sodium salt) of gluconate can be formed. In some embodiments, the salt of gluconate in the final in situ lignin-modified wood may be dominant (e.g., as compared to the salt of phenol and/or the salt of alduronic acid).

### Processing Methods

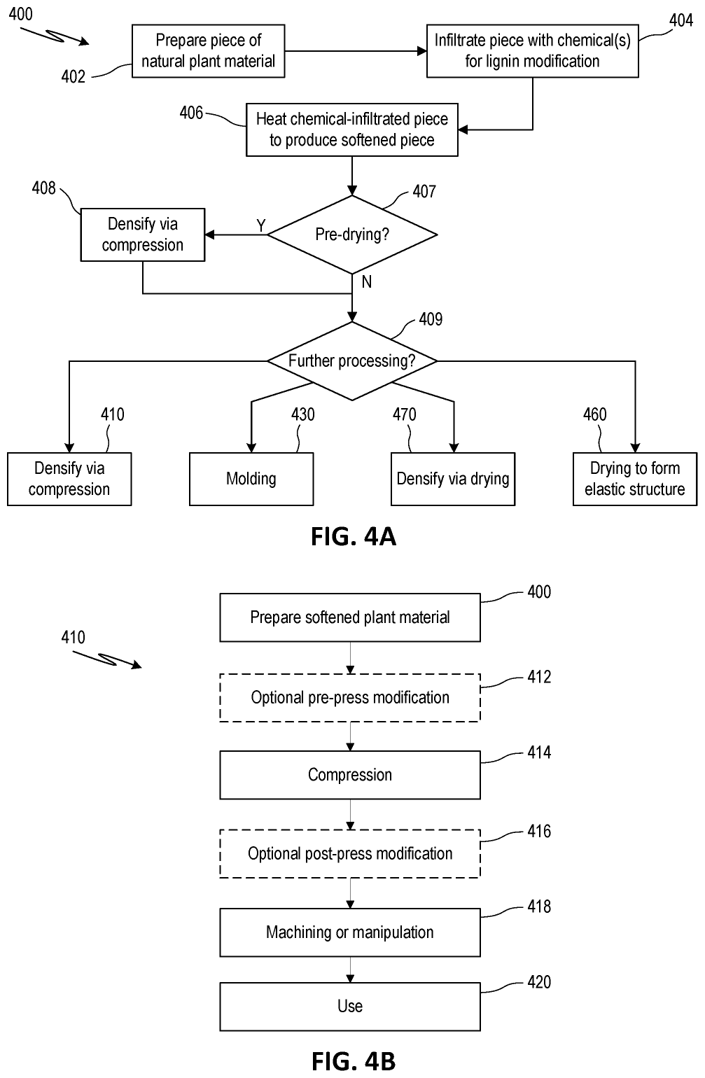

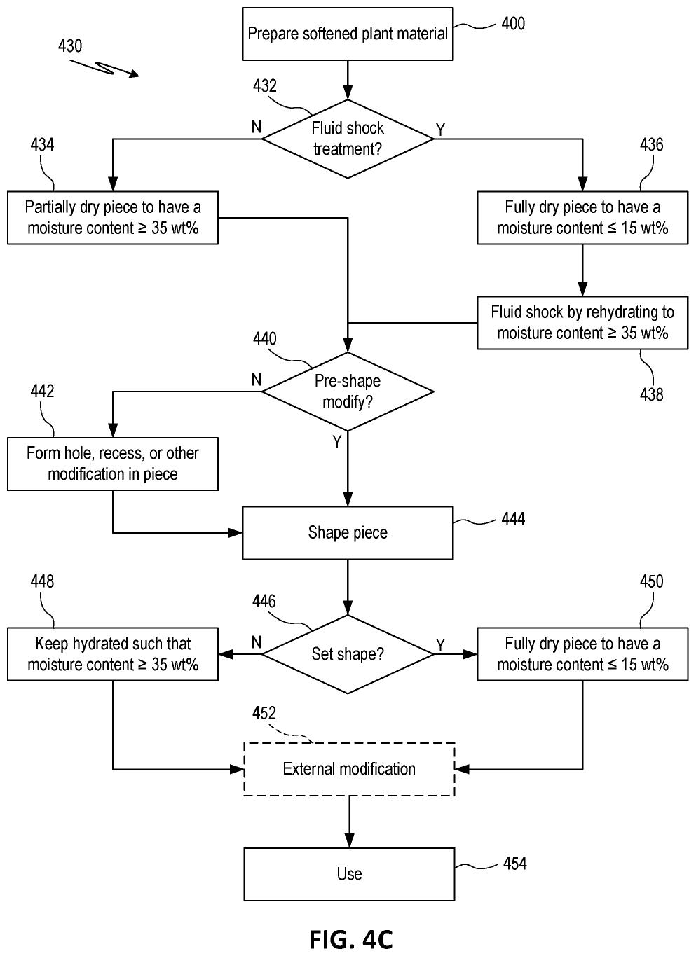

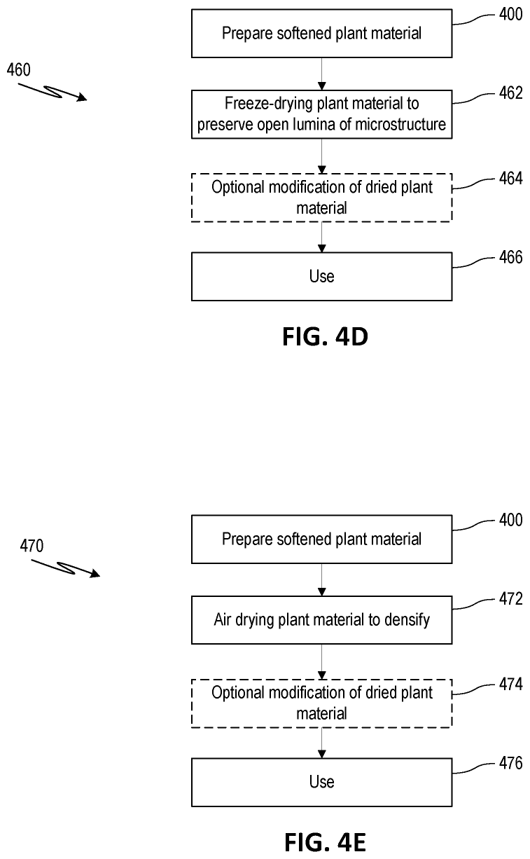

FIG. 4A illustrates a method 400 for forming lignin-modified fibrous plant materials. The method 400 can begin at process block 402, where a piece of natural fibrous plant material is prepared. For example, the preparing of process block 402 can include cutting, removing, or otherwise separating the piece of wood from a parent tree. In some embodiments, the cutting can form the natural fibrous plant material into a substantially flat planar structure, with a direction of cellulose fibers extending parallel to a plane of the structure (e.g., longitudinal cut or rotary cut) or extending perpendicular to a plane of the structure (e.g., radial cut). Optionally, in some embodiments, the preparing can include pre-processing of the piece of natural fibrous plant material, for example, cleaning to remove any undesirable material or contamination in preparation for subsequent processing, forming the natural cellulose-based material into a particular shape in preparation for subsequent processing (e.g., slicing into strips), or any combination of the foregoing. For example, in some embodiments, the cutting can form the wood into any one-dimensional (e.g., an elongated structure, where a thickness and a width are both at least an order of magnitude less than its length), two-dimensional (e.g., a substantially flat planar structure, where a thickness is at least an order of magnitude less than its length and width), or three-dimensional (e.g., a block, where a thickness, width, and length are all within an order of magnitude of each other) structure. In some embodiments, the piece of natural plant fibrous plant material can be provided (and/or formed) such that a tangential direction thereof is substantially parallel to a direction of desired elasticity in the final product (e.g., subject to process block 460).

The method 400 can proceed to process block 404, where the piece of natural fibrous plant material can be infiltrated with one or more chemicals to modify lignin therein. For example, in some embodiments, the infiltration can be by soaking the piece of natural fibrous plant material in a solution containing the one or more chemicals under vacuum. In some embodiments, the chemical solution can contain at least one chemical component that has OH-ions or is otherwise capable of producing OH⁻ ions in solution. In some embodiments, one, some, or all of the chemicals in the solution can be alkaline. In some embodiments, the chemical solution includes p-toluenesulfonic acid, NaOH, LiOH, KOH, Na₂O, or any combination thereof. Exemplary combinations of chemicals can include, but are not limited to, p-toluenesulfonic acid, NaOH, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing.

For example, in some embodiments, the piece of fibrous plant material (e.g., basswood) can be immersed in a chemical solution (e.g., 2-5% NaOH) in a container. The container can then be placed in a vacuum box and subjected to vacuum. In this way, the air in the fibrous plant material can be drawn out and form a negative pressure. When the vacuum pump is turned off, the negative pressure inside the fibrous plant material can suck the solution into the fibrous plant material through the natural channels therein (e.g., lumina defined by longitudinal cells). The process can be repeated more than once (e.g., 3 times), such that the channels inside the fibrous plant material can be filled with the chemical solution (e.g., about 2 hours). After this process, the moisture content can increase from ˜10.2% (e.g., for natural wood) to ˜70% or greater. In some embodiments, the chemical infiltration can be performed without heating, e.g., at room temperature (20-30° C., such as ˜22-23° C.). In some embodiments, the chemical solution is not agitated in order to avoid disruption to the cellulose-based microstructure of the fibrous plant material.

The method 400 can proceed to process block 406, where the modification may be activated by subjecting the infiltrated piece of fibrous plant material to an elevated temperature, for example, greater than 80° C. (e.g., 80-180° C., such as 120-160° C.), thereby resulting in a softened fibrous plant material (e.g., softened as compared to the native fibrous plant material). In some embodiments, the subjecting to an elevated temperature of process block 406 can be achieved via steam heating, for example, via steam generated in an enclosed reactor, via a steam flow in a flow-through reactor, and/or via steam from a superheated steam generator. Alternatively or additionally, in some embodiments, the subjecting to an elevated temperature of process block 406 can be achieved via dry heating, for example, via conduction and/or radiation of heat energy from one or more heating elements without separate use of steam. In some embodiments, during process block 406, infiltrated piece of fibrous plant material can be subjected to the elevated temperature for a first time period of, for example, 1-5 hours (e.g., depending on the size of the fibrous plant material, with thicker pieces requiring longer heating times). In some embodiments, after the first time period, any steam generated by heating of the infiltrated piece of fibrous plant material can be released, for example, by opening a pressure release (e.g., relief valve) of the reactor. For example, in some embodiments, the pressure release can be effective to remove ˜50% of moisture in the modified plant material. For example, in some embodiments, the now softened plant material can have a moisture content in a range of 30-50 wt %, inclusive.

After process block 406, the method 400 can proceed to decision block 407, where it is determined if the softened plant material should be subject to pre-drying before the further processing, for example, to avoid or at least reduce any waste liquid produced during a final densification process. If pre-drying is desired, the method 400 can proceed to process block 408, where the softened plant material can be subject to pre-drying. In some embodiments, the pre-drying can comprise an air-drying process, for example, allowing the softened fibrous plant material to naturally dry in static or moving air, which air may be at any temperature, such as room temperature (e.g., ˜22-23° C.) or at an elevated temperature (e.g., greater than 23° C.). Alternatively or additionally, the drying can include any of conductive, convective, and/or radiative heating processes, including but not limited to an air-drying process, a vacuum-assisted drying process, an oven drying process, a freeze-drying process, a critical point drying process, a microwave drying process, or any combination of the above. In some embodiments, the pre-drying may be effective to reduce the moisture content of the softened plant material, but without removing too much moisture that the plant material loses its softened nature (e.g., such that the moisture content is greater than or equal to ˜8-10 wt %). In some embodiments, the pre-drying may be effective to reduce a moisture content of the plant material from greater than 30 wt % (e.g., 30-50 wt %) to within a range of, for example, 10-20 wt % (e.g., ˜15 wt %). While moisture may be removed from the softened plant material via the heating and/or pre-drying (e.g., via evaporation), the removed moisture may be substantially free of residual salts and/or chemicals from the in situ lignin-modification. Rather, in some embodiments, the chemicals can be substantially consumed by the modification, and the residual salts can be retained within the microstructure of the softened plant material.

After process block 408, or if pre-drying was not desired at decision block 407, the method 400 can proceed via decision block 409 to further processing of the softened plant material depending on one or more desired applications. In some embodiments, the softened plant material can be subject to densification at process block 410, for example, to produce densified fibrous plant material having a high strength (e.g., greater than 500 MPa, such as ˜560 MPa). In some embodiments, the densification or other associated processing can be, for example, as described in U.S. Publication No. 2020/0223091, published Jul. 16, 2020 and entitled “Strong and Tough Structural Wood Materials, and Methods for Fabricating and Use Thereof,” or International Publication No. WO 2021/108576, published Jun. 3, 2021 and entitled “Bamboo Structures, and Methods for Fabrication and Use Thereof,” each of which is incorporated herein by reference. Alternatively or additionally, the softened plant material can be subject to molding at process block 430, for example, to produce 3-D moldable or 3-D molded plant material. In some embodiments, the molding or other associated processing can be, for example, as described in International Publication No. WO 2021/216803, published Oct. 28, 2021 and entitled “Moldable and Molded Cellulose-based Structural Materials, and Systems and Methods for Forming and Use Thereof,” which is incorporated herein by reference. Alternatively or additionally, the softened plant material can be subject to drying at process block 460 to form a flexible structure or an anisotropically-elastic structure. In some embodiments, the drying or other associated processing can be, for example, as described in U.S. Publication No. 2020/0282591, published Sep. 10, 2020 and entitled “Flexible Wood Structures and Devices, and Methods for Fabricating and Use Thereof,” or pending International Application No. PCT/US22/31289, filed May 27, 2022 and entitled “Wood Materials Having Anisotropic Elasticity, and Methods for Fabrication and Use Thereof,” each of which is incorporated herein by reference. Alternatively or additionally, the softened plant material can be subject to drying at process block 470 to form a densified structure, for example, a self-densified fibrous plant material having a high strength (e.g., greater than 300 MPa, such as ˜304 MPa).

After method 400, the processed fibrous plant material can be used in a particular application or adapted for use in a particular application. For example, the modified plant product can be subjected to further processing, such as machining, cutting, or otherwise forming the contiguous piece into a particular shape. The use of the modified plant product can involve use of the modified plant product by itself or assembling it together with different plant species (conventional, modified, or otherwise) and/or non-plant materials (e.g., metal, metal alloy, plastic, ceramic, composite, etc.) to form a heterogenous composite structure.

Although some of blocks 402-410, 430, 460, and 470 of method 400 have been described as being performed once, in some embodiments, multiple repetitions of a particular process block may be employed before proceeding to the next decision block or process block. In addition, although blocks 402-410, 430, 460, and 470 of method 400 have been separately illustrated and described, in some embodiments, process blocks may be combined and performed together (simultaneously or sequentially). Moreover, although FIG. 4A illustrates a particular order for blocks 402-410, 430, 460, and 470, embodiments of the disclosed subject matter are not limited thereto. Indeed, in certain embodiments, the blocks may occur in a different order than illustrated or simultaneously with other blocks.

Since all chemicals are consumed in process blocks 402-406, the resulting softened plant material can exhibit a neutral pH. Moreover, unlike prior delignification processes, no or minimal black liquor can be produced by process blocks 402-406, and the products of degradation of the native cellulose, hemicellulose, and lignin can all be immobilized inside the channels of the softened plant material.

Referring to FIG. 4B, a method 410 for densifying the softened fibrous plant material is shown. For example, softened fibrous plant material can be prepared according to method 400 of FIG. 4A. The method 410 can proceed to optional process block 412, where an internal modification of the softened fibrous plant material can be performed prior to pressing. Although the term “internal” is used to refer to the modification of process block 412, it is contemplated that, in some embodiments, the modification may be applied to external features as well as internal features of the softened plant material, while in other embodiments the modification may be applied to either internal features or external features of the softened plant material without otherwise affecting the other feature. In some embodiments, the internal modification can include forming, depositing, or otherwise providing non-native particles on surfaces of the softened plant material. Such surfaces can include at least internal surfaces, e.g., cell walls lining the lumina, but may also include external surfaces of the softened plant material. The non-native particles incorporated onto the surfaces of the softened plant material can imbue the final structure with certain advantageous properties, such as hydrophobicity, weatherability, corrosion resistance (e.g., salt water resistant), and/or flame resistance among other properties. For example, in some embodiments, hydrophobic nanoparticles (e.g., SiO₂ nanoparticles) can be formed on surfaces of the softened plant material.

Alternatively or additionally, in some embodiments, the internal modification can include performing a further chemical treatment that modifies the surface chemistry of the softened plant material. For example, in some embodiments, the further chemical treatment can provide weatherability or corrosion resistance can include at least one of cupramate (CDDC), ammoniacal copper quaternary (ACQ), chromated copper arsenate (CCA), ammoniacal copper zinc arsenate (ACZA), copper naphthenate, acid copper chromate, copper citrate, copper azole, copper 8-hydroxyquinolinate, pentachlorophenol, zinc naphthenate, copper naphthenate, creosote, titanium dioxide, propiconazole, tebuconazole, cyproconazole, boric acid, borax, organic iodide (IPBC), and Na₂B₈O₁₃·4H₂O.

Alternatively or additionally, in some embodiments, the internal modification of process block 412 can include infiltrating the softened plant material with one or more polymers (or polymer precursors). For example, the softened plant material can be immersed in a polymer solution under vacuum to form a hybrid material. The polymer can be any type of polymer capable of infiltrating into the pores of the softened plant material, for example, a synthetic polymer, a natural polymer, a thermosetting polymer, or a thermoplastic polymer. For example, in some embodiments, the polymer can be epoxy resin, polyvinyl alcohol (PVA), polyethylene glycol (PEO), polyamide (PA), polyethylene terephthalate (PET), polybutylene terephthalate (PBT), polytrimethylene terephthalate (PTT), polyacrylonitrile (PAN), polycaprolactam (PA6), poly(m-phenylene isophthalamide) (PMIA), poly-p-phenylene terephthalamide (PPTA), polyurethane (PU), polycarbonate (PC), polypropylene (PP), high-density polyethylene (HDPE), polystyrene (PS), polycaprolactone (PCL), polybutylene succinate (PBS), polybutylene adipate terephthalate (PBAT), poly(butylene succinate-co-butylene adipate) (PBSA), polyhydroxybutyrate (PHB), poly(3-hydroxybutyrate-co-3-hydroxyvalerate) (PHBV), poly(glycolic acid) (PGA), polypyrrole (PPy), polythiophene (PTh), polyvinylidene fluoride (PVDF), polyvinyl fluoride (PVF), ethylene vinyl alcohol (EVOH), poly(vinylidene chloride) (PVDC), polyxylylene adipamide (MXD6), polyethylene (PE), polyvinyl chloride (PVC), poly(methyl methacrylate) (PMMA), acrylonitrile butadiene styrene (ABS), polyimide (PI), polyethylenimine (PEI), polylactic acid (PLA), octadecyl trichlorosilane (OTS), polyoctahedral silsesquioxane (POSS), paramethylstyrene (PMS), polydimethylsiloxane (PDMS), poly(ethylene naphthalate (PEN), a graft copolymer of acrylonitrile-butadiene-styrene-methylmethacrylate (ABSM), dodecyltrimethoxysilane (DTMS), rosin, chitin, chitosan, protain, plant oil, lignin, hemicellulose, carboxymethyl cellulose, cellulose acetate, starch, agar, or any combination of the above.

The method 410 can proceed to process block 414, where the softened plant material is pressed in a direction crossing its longitudinal direction. In some embodiments, the pressing can be in a direction substantially perpendicular to the longitudinal direction, while in other embodiments the pressing may have a force component perpendicular to the longitudinal direction. In either case, the pressing can be effective to reduce a thickness of the softened plant material, thereby increasing its density as well as collapsing (at least partially) the natural lumina (e.g., vessels, lumen in each fiber, parenchyma cells, etc.), voids, and/or gaps within the cross-section of the softened plant material. In some embodiments, the pressing can be along a single direction (e.g., along radial direction R), for example, to reduce a thickness of the softened plant material (e.g., at least a 5:2 reduction in dimension as compared to the softened plant material prior to pressing). Alternatively or additionally, in some embodiments, the softened plant material can be simultaneously pressed in two directions (e.g., along radial direction R and a second direction perpendicular to both the radial direction R and the longitudinal direction L), for example, to reduce a cross-sectional area of the softened plant material (e.g., to produce a densified rectangular bar). Alternatively or additionally, in some embodiments, the softened plant material can be sequentially pressed in different directions (e.g., first along radial direction R and then along a second direction perpendicular to the radial direction R and longitudinal direction L).

In some embodiments, the pressing may be performed without any prior drying of the softened plant material or with the softened plant material retaining at least some water or other fluid therein. The pressing can thus be effective to remove at least some water or other fluid from the softened plant material at the same time as its dimension is reduced and density increased. In some embodiments, a separate drying process can be combined with the pressing process. For example, the softened plant material may initially be pressed to cause densification and remove at least some water or fluid therefrom, followed by a drying process (e.g., air drying) to remove the remaining water or fluid. Alternatively, in some embodiments, the softened plant material may initially be dried to remove at least some water or fluid therefrom (e.g., initial drying in a humidity chamber followed by air drying at room temperature, such that the moisture content of the plant material approaches but remains greater than 15 wt %, for example, 10 wt %), followed by pressing to cause densification (and potentially further removal of water or other fluid, for example, a moisture content less than 10 wt %, such as 3-8 wt %).

In some embodiments, the pressing can encourage hydrogen bond formation between the cellulose-based fibers of the cell walls of the softened plant material, thereby improving mechanical properties of the densified plant material. Moreover, any particles or materials formed on surfaces of the softened plant material or within the softened plant material (e.g., via the internal modification of process block 414) can be retained after the pressing, with the particles/materials on internal surfaces being embedded within the collapsed lumina and intertwined cell walls.

The pressure and timing of the pressing can be a factor of the size of softened plant material prior to pressing, the desired size of the plant material after pressing, the water or fluid content within the softened plant material (if any), the temperature at which the pressing is performed, relative humidity, the characteristics of material (e.g., infiltrated polymer) from the internal modification (if any), and/or other factors. For example, the softened plant material can be held under pressure for a time period of at least 1 minute to up to several hours (e.g., 1-180 minutes, inclusive). In some embodiments, the softened plant material can be held under pressure for 3-72 hours, inclusive. In some embodiments, the pressing can be performed at a pressure between 0.5 MPa and 20 MPa, inclusive, for example, 5 MPa. In some embodiments the pressing may be performed without heating (e.g., cold pressing), while in other embodiments the pressing may be performed with heating (e.g., hot pressing). For example, the pressing may be performed at a temperature between 20° C. and 160° C., e.g., greater than or equal to 100° C.

The method 410 can proceed to optional process block 416, where the densified plant material may be subject to an external modification. Although the term “external” is used to refer to the modification of process block 416, it is contemplated that, in some embodiments, the modification may be applied to internal features as well as external features of the densified plant material, while in other embodiments the modification may be applied to either internal features or external features of the densified plant material without otherwise affecting the other feature. In some embodiments, the external modification can include forming, depositing, or otherwise providing a coating on one or more external surfaces of the densified plant material. The coating may imbue the densified plant material with certain advantageous properties, such as but not limited to hydrophobicity, weatherability, corrosion resistance (e.g., salt water resistant), and/or flame resistance. For example, the coating can comprise an oil-based paint, a hydrophobic paint, a polymer coating, and/or a fire-resistant coating. In some embodiments, the fire-resistant coating can include nanoparticles (e.g., boron nitride nanoparticles). Alternatively or additionally, in some embodiments, a coating for the bamboo can include boron nitride (BN), montmorillonite clay, hydrotalcite, silicon dioxide (SiO₂), sodium silicate, calcium carbonate (CaCO₃), aluminum hydroxide (Al(OH)₃), magnesium hydroxide (Mg(OH)₂), magnesium carbonate (MgCO₃), aluminum sulfate, iron sulfate, zinc borate, boric acid, borax, triphenyl phosphate (TPP), melamine, polyurethane, ammonium polyphosphate, phosphate, phosphite ester, ammonium phosphate, ammonium sulfate, phosphonate, diammonium phosphate (DAP), ammonium dihydrogen phosphate, monoammonium phosphate (MAP), guanylurea phosphate (GUP), guanidine dihydrogen phosphate, antimony pentoxide, or any combination of the above.

The method 410 can proceed to process block 418, where the densified plant material can be machined, cut, and/or otherwise physically manipulated (e.g., bending) in preparation for eventual use. Machining processes can include, but are not limited to, cutting (e.g., sawing), drilling, woodturning, tapping, boring, carving, routing, sanding, grinding, and abrasive tumbling. Manipulating process can include, but are not limited to, bending, molding, and other shaping techniques.

The method 410 can proceed to process block 420, where the densified plant material can be used in a particular application. For example, the densified plant material can be adapted for use as structural material (e.g., a load bearing component or a non-load bearing component). For example, the densified plant material can have a mechanical strength (e.g., tensile strength) of at least 500 MPa. Other applications beyond those specifically listed are also possible for the densified plant material. Indeed, one of ordinary skill in the art will readily appreciate that the densified plant materials disclosed herein can be adapted to other applications based on the teachings of the present disclosure.

Although blocks 412-420 of method 410 have been described as being performed once, in some embodiments, multiple repetitions of a particular process block may be employed before proceeding to the next decision block or process block. In addition, although blocks 412-420 of method 410 have been separately illustrated and described, in some embodiments, process blocks may be combined and performed together (simultaneously or sequentially). Moreover, although FIG. 4B illustrates a particular order for blocks 412-420, embodiments of the disclosed subject matter are not limited thereto. Indeed, in certain embodiments, the blocks may occur in a different order than illustrated or simultaneously with other blocks. For example, the shaping of process block 418 can occur before the external modification of process block 416.

Referring to FIG. 4C, a method 430 for molding the softened fibrous plant material is shown. For example, softened fibrous plant material can be prepared according to method 400 of FIG. 4A. The method 430 can proceed to decision block 432, where it is determined if a fluid shock technique will be performed. If it is determined that a fluid shock will not be performed, the method 430 can proceed from decision block 432 to process block 434, where the softened fibrous plant material can be partially dried. For example, the partial drying of process block 434 can be such that the softened fibrous plant material has a moisture content of at least 35 wt % (e.g., ≥50 wt %). Otherwise, if it is determined that a fluid shock will be performed, the method 430 can proceed from decision block 432 to process block 436, where the softened fibrous plant material is fully dried. For example, the full drying of process block 436 can be such that the softened fibrous plant material has a moisture content 15 wt % or less (e.g., less than ˜8-12 wt %, such as 3-8 wt %, inclusive).

The drying of either process block 434 or process block 436 can include any of conductive, convective, and/or radiative heating processes, including but not limited to an air-drying process, a vacuum-assisted drying process, an oven drying process, a freeze-drying process, a critical point drying process, a microwave drying process, or any combination of the above. For example, an air-drying process can include allowing the softened fibrous plant material to naturally dry in static or moving air, which air may be at any temperature, such as room temperature (e.g., 23° C.) or at an elevated temperature (e.g., greater than 23° C.). For example, a vacuum-assisted drying process can include subjecting the softened fibrous plant material to reduced pressure, e.g., less than 1 bar, for example, in a vacuum chamber or vacuum oven. For example, an oven drying process can include using an oven, hot plate, or other conductive, convective, or radiative heating apparatus to heat the softened fibrous plant material at an elevated temperature (e.g., greater than 23° C.), for example, 70° C. or greater. For example, a freeze-drying process can include reducing a temperature of the softened fibrous plant material to below a freezing point of the fluid therein (e.g., less than 0° C.), then reducing a pressure to allow the frozen fluid therein to sublime (e.g., less than a few millibars). For example, a critical point drying process can include immersing the softened fibrous plant material in a fluid (e.g., liquid carbon dioxide), increasing a temperature and pressure of the softened fibrous plant material past a critical point of the fluid (e.g., 7.39 MPa, 31.1° C. for carbon dioxide), and then gradually releasing the pressure to remove the now gaseous fluid. For example, a microwave drying process can include using a microwave oven or other microwave generating apparatus to induce dielectric heating within the softened fibrous plant material by exposing it to electromagnetic radiation having a frequency in the microwave regime (e.g., 300 MHz to 300 GHz), for example, a frequency of ˜915 MHz or ˜2.45 GHz.

In some embodiments, the full drying of process block 436 causes shrinkage of the softened fibrous plant material, which in turn causes significant buckling of the cell walls. In some embodiments, the lumina formed by the longitudinal cells may collapse (e.g., fully collapse such that facing surface of the channel wall are in contact, or at least significantly narrow). After the drying of process block 436, the method 430 can proceed to process block 438, where the dried softened fibrous plant material is rehydrated using a fluid shock technique. For example, the dried softened fibrous plant material can be partially or fully immersed in a fluid (e.g., water, alcohol, or any combination thereof) for a short period of time (e.g., several minutes, such as 3 minutes or less, for example, on the order of seconds) such that the rehydrated material has a moisture content of at least 35 wt % (e.g., around 50 wt %). Methods for rehydration other than immersion in fluid are also possible according to one or more embodiments. For example, rehydration can be achieved by exposure to a humidified environment.

In some embodiments, the rehydration is effective to re-swell the cells wall and allow larger lumina (e.g., vessels) to re-open while smaller lumina (e.g., fiber cells) to remain substantially collapsed. The swelling introduced by the fluid shock can create wrinkles in the cell wall structure, which can allow the softened fibrous plant material to accommodate severe tension and compression without damage.

With the softened fibrous plant material having a moisture content of at least 35 wt % after either process block 434 or process block 438, the method 430 can proceed to decision block 440, where it is determined if a pre-shaping modification is desired. If such a modification is desired, the method 430 can proceed to process block 442, where a non-machining technique (e.g., without removing substantive amounts of material to form the modification) is used to form a hole, opening, recess, or other surface modification. The modification can be made while the moisture content of the softened fibrous plant material is at least 35 wt % and therefore in a substantially flexible/moldable state. As a result, the cellulose fibers may retain sufficient motility so as to bend around the formation of the hole, opening, or recess without breaking.

After the modification of process block 442, or if no modification was desired at decision block 440, the method 430 can proceed to process block 444, where the softened fibrous plant material can be shaped to have a desired configuration, such as a 3-D configuration. The shaping of process block 444 can include bending, folding, pushing, pressing, molding (e.g., using a mold) or otherwise non-destructively forming (e.g., no removal of material) the softened fibrous plant material to have the desired configuration. During the shaping, the moisture content of the softened fibrous plant material is at least 35 wt % and therefore in a substantially flexible/moldable state. As a result, the softened fibrous plant material readily adopts the shaped configuration and can return to its original unshaped configuration without damage.

The method 400 can proceed to decision block 446, where it is determined if the softened fibrous plant material should be set in the shaped configuration or if the softened fibrous plant material should instead be maintained in a flexible/moldable state. If it is desired to maintain the softened fibrous plant material as moldable material, the method 430 can proceed to process block 448, where the moisture content thereof is maintained at or above 35 wt %. Otherwise, if it is desired to set the softened fibrous plant material in the shaped configuration, the method 430 can proceed to process block 450, where the softened fibrous plant material can be fully dried while maintaining the shaped configuration, such that the moisture content thereof is reduced to at or below 15 wt % (e.g., in a range of 3-8 wt %). The drying of process block 450 may be performed in a manner similar to that described above with respect to process block 436. Alternatively or additionally, in some embodiments, the drying can be a by-product of the shaping, for example, by using a hot press to simultaneously mold and dry the softened fibrous plant material. In such embodiments, the shaping can be effective to further densify the softened fibrous plant material prior to fully drying, which densification may further improve the mechanical properties of the molded material. Once fully dried, the fibrous plant material may be rigid and incapable of further shape manipulation without plastic deformation, thereby forming a molded structure.

In some embodiments, the method 430 can proceed from process block 448 or process block 450 to optional process block 452, where an external modification may be applied. For example, the fibrous plant material can be sealed to prevent ingress of moisture or egress of moisture and thereby maintaining a desired moldable (e.g., flexible) or molded (e.g., rigid) state of the material. In some embodiments, the sealing is by placing the fibrous plant material in a sealed or controlled environment. Alternatively or additionally, the sealing can be achieved by a protective layer or coating provided over exposed surfaces of the fibrous plant material. For example, the protecting layer or coating can be a polyurethane coating, paint, silane hydrophobic coating, or any other coating effective to prevent, or at least restrict, movement of moisture into or out of the fibrous plant material. Alternatively or additionally, the external modification can include a destructive modification, for example, machining or cutting to prepare the lignin-modified fibrous plant material for subsequent use.

The method 430 can proceed to process block 454, where the lignin-modified fibrous plant material, in either the moldable state or molded state, can be used in a particular application or adapted for use in a particular application. In some embodiments, the molded lignin-modified fibrous plant material can be used as a structural material, for example, assembled together with non-plant materials (e.g., metal, metal alloy, plastic, ceramic, composite, etc.) to form a heterogenous composite structure. Alternatively, in some embodiments, the moldable lignin-modified fibrous plant material can be used as a flexible substrate or structure, for example, as a scaffold for robotic actuation or a substrate for electronics.

Although some of blocks 432-454 of method 430 have been described as being performed once, in some embodiments, multiple repetitions of a particular process block may be employed before proceeding to the next decision block or process block. In addition, although blocks 432-454 of method 430 have been separately illustrated and described, in some embodiments, process blocks may be combined and performed together (simultaneously or sequentially). For example, as noted above, the drying of process block 450 and the shaping of process block 444 may occur simultaneously. Moreover, although FIG. 4C illustrates a particular order for blocks 432-454, embodiments of the disclosed subject matter are not limited thereto. Indeed, in certain embodiments, the blocks may occur in a different order than illustrated or simultaneously with other blocks. For example, the modification of process block 442 can occur after the shaping of process block 444, while the softened fibrous plant material remains moldable.

Referring to FIG. 4D, a method 460 for drying to form a flexible structure or an anisotropically-elastic structure is shown. For example, softened fibrous plant material can be prepared according to method 400 of FIG. 4A. The method 460 can proceed to process block 462, where the softened fibrous plant material can be subjected to drying, for example, such that the moisture content therein is less than 15 wt % (e.g., 4-12 wt %). In some embodiments, the drying can be such that the structures of the longitudinally-extending lumina in the microstructure of the softened fibrous plant material are retained (e.g., with a cross-sectional shape substantially the same as that in the native fibrous plant material), for example, by avoiding surface-tension-induced collapse or crumpling from evaporation of water. For example, the drying can comprise a freeze-drying process, a critical point drying process, a solvent exchange process, or any combination of the above. For example, the freeze-drying process can include reducing a temperature of the softened fibrous plant material to below a freezing point of the fluid therein (e.g., less than 0° C.), then reducing a pressure to allow the frozen fluid therein to sublime (e.g., less than a few millibars). For example, the critical point drying process can include immersing the softened fibrous plant material in a fluid (e.g., liquid carbon dioxide), increasing a temperature and pressure of the softened fibrous plant material past a critical point of the fluid (e.g., 7.39 MPa, 31.1° C. for carbon dioxide), and then gradually releasing the pressure to remove the now gaseous fluid. For example, the solvent exchange process can include replacing water within the softened fibrous plant material with an organic solvent or alcohol (e.g., acetone, ethanol, etc.), which may be more readily evaporated without collapsing the longitudinally-extending lumina.

In some embodiments, after the drying, the lignin-modified fibrous plant material can be elastic at least along its tangential direction, for example, due at least in part to removal of ray cells. In some embodiments, the lignin-modified fibrous plant material can remain inelastic along its radial and longitudinal directions, for example, due at least in part to retention of the longitudinal cells. In such embodiments, the dried lignin-modified fibrous plant material can exhibit asymmetric elasticity or anisotropic elasticity (e.g., substantially elastic along tangential direction, T, and substantially inelastic along radial direction, R, and longitudinal direction, L). Alternatively, in some embodiments, after the drying, the lignin-modified fibrous plant material can be flexible (e.g., isotropically or anisotropically).

The method 460 can proceed to optional process block 464, where the lignin-modified fibrous plant material can optionally be subjected to one or more modifications. In some embodiments, the optional modification can comprise sealing the dried, lignin-modified fibrous plant material, for example, to prevent ingress of moisture or egress of moisture. For example, the sealing can be by placing the lignin-modified fibrous plant material in a sealed or controlled environment. Alternatively or additionally, the sealing can be achieved by a protective layer or coating provided over exposed surfaces of the lignin-modified fibrous plant material. For example, the protecting layer or coating can be a polyurethane coating, paint, silane hydrophobic coating, or any other coating effective to prevent, or at least restrict, movement of moisture into or out of the lignin-modified fibrous plant material. Alternatively or additionally, the optional modification can include a destructive modification, for example, machining or cutting to prepare the lignin-modified fibrous plant material for subsequent use.

In some embodiments, the optional modification can include applying a coating to external surfaces and/or internal surfaces of the lignin-modified fibrous plant material, and/or coupling particles to the external surfaces and/or internal surfaces of the lignin-modified fibrous plant material. In some embodiments, the coating can have a thickness less than or equal to 10 μm, for example, in a range of 10 nm-10 μm, inclusive. In some embodiments, the coating may be such that the porosity of the lignin-modified fibrous plant material remains at least 50%. In some embodiments, the coating or the coupled particles can include a conductive material, a semiconductive material, or an insulating material. For example, the coating or the coupled particles can include nanoparticles, nanowires, graphene, graphite, ceramic oxide, single-walled carbon nanotubes (CNTs), double-walled CNTs, multi-walled CNTs, polyaniline, carbon black, graphite, hard carbon (e.g., char or non-graphitizing carbon), reduced graphene oxide, graphene, plasmonic metallic nanoparticles, catalytic nanoparticles, electroactive nanoparticles, metal alloy nanoparticles, semiconductor nanoparticles, sulfides, phosphides, borides, oxides, or any combination of the foregoing. Examples of materials for the plasmonic metallic nanoparticles include but are not limited to Au, Pt. Ag, Pd, and Ru. The metallic nanoparticles and the metal alloy nanoparticles can include, but are not limited to, Pt, Pd. Au, Ag, Ni, Co, Ru, and Fe. Examples of materials for the semiconductor nanoparticles include CuFeSe₂ or any other semiconductor. Examples of materials for the sulfides include, but are not limited to, MoS₂, CoSₓ, and FeS₂, where x is an integer. Examples of materials for the phosphides include, but are not limited to, CoP, NiP₂, and MoPₓ, where x is an integer. Examples of materials for the borides include, but are not limited to, CoB, MoB, and NiB. Examples of materials for the oxides include, but are not limited to, MnO₂, Fe₂O₃, CoO, and NiO.

Alternatively or additionally, in some embodiments, the coating can comprise a hydrophobic material, a water-resistant material, a weather-resistant material, or any combination of the foregoing. For example, the coating can comprise manganese oxide polystyrene (MnO₃/PS) nano-composite, zinc oxide polystyrene (ZnO/PS) nano-composite, precipitated calcium carbonate, carbon nanotube structures, silica nano-coating, fluorinated silanes, polyethylene, polystyrene, polyvinylchloride, polytetrafluorethylene, polydimethylsiloxane, polyester, polyurethane, acrylic, epoxy, or any combination of the foregoing. Alternatively or additionally, the coating can comprise sodium chloride, potassium sulphate, sodium sulphate, calcium sulphate, magnesium sulphate, copper sulphate, sodium nitrate, sodium carbonate, calcium, silicon, phosphorus, silver, titanium oxide, or any combination of the foregoing.

In some embodiments, the optional modification can include infiltrating the lignin-modified fibrous plant material with another elastic or flexible material, such as a polymer (or polymer precursor) or protein, so as to form an elastic composite. In some embodiments, the material can substantially or at least mostly fill the open lumina of the microstructure of the lignin-modified fibrous plant material. In some embodiments, the infiltration may be such that the porosity of the lignin-modified fibrous plant material is reduced to less than or equal to 10%. For example, the elastic or flexible material can be natural or synthetic polyisoprene, polybutadiene, chloroprene rubber (e.g., Baypren®), polychloroprene, neoprene, butyl rubber, halogenated butyl rubber, styrene-butadiene rubber (e.g., copolymer of styrene and butadiene), polydimethylsiloxane (PDMS), nitrile rubber (e.g., copolymer of butadiene and acrylonitrile), hydrogenated nitrile rubber (e.g., Therban®, Zetpol®, etc.), ethylene propylene rubber (e.g., a copolymer of ethene and propene), ethylene propylene diene monomer (EPDM) rubber, epichlorohydrin rubber, polyacrylic rubber, silicon rubber, fluorosilicone rubber, fluoroelastomer (e.g., Viton™, Tecnoflon®, Fluorel™, AFLAS®, DAI-EL™), perfluoroelastomer (e.g., Tecnoflon® PFR, Kalrez®, Chemraz®, Perlast®), polyether block amide, chlorosulfonated polyethylene (e.g., Hypalon®), ethylene-vinyl acetate, thermoplastic elastomer, resilin, elastin, polysulfide rubber, elastolefin, poly(dichlorophosphazene), an inorganic rubber from hexachlorophosphaze polymerization, or any combination of the foregoing.

The method 460 can proceed to process block 466, where the lignin-modified fibrous plant material (or composite) can be used in a particular application or adapted for use in a particular application. In some embodiments, the lignin-modified fibrous plant material (or composite) can be used as an anisotropic resilient structure that can completely recover its original shape after being subjected to a compressive force along its tangential direction (while remaining substantially inelastic along the orthogonal radial and longitudinal directions). In some embodiments, the lignin-modified fibrous plant material (or composite) can be employed as a sound-absorbing or force-absorbing material. In some embodiments, the lignin-modified fibrous plant material can be oriented with its inelastic plane (e.g., along radial and longitudinal directions) to support a force applied to it (e.g., function as a structural member) while its elastic direction (e.g., along the tangential direction) absorbs a force applied to it (e.g., acts as a sound absorbing member).

The lignin-modified fibrous plant material (or composite) can be used in any application where a resilient and/or spongy material may be useful, such as, but not limited to building (construction) or structural materials (e.g., insulation, flooring, etc.), sound absorbers, parts of footwear (e.g., inserts or insoles, outsoles, midsoles, uppers, tongues, etc.), cushioning (e.g., packing materials, mattresses, pillows, cushions, etc.), seals (e.g., gaskets, O-rings, etc.), isolation devices (e.g., damping pad, anti-vibration mounts, etc.), damping elements (e.g., shock absorber), energy storage or harvesting devices, elastic substrates (e.g., flexible conductors, flexible electronic devices, wearable devices, etc.), shape memory structures, and tires. In some embodiments, the lignin-modified fibrous plant material (or composite) can be used as a structural material, for example, assembled together with non-plant materials (e.g., metal, metal alloy, plastic, ceramic, composite, etc.) to form a heterogenous composite structure.

Although blocks 462-466 in FIG. 4D have been described as being performed once, in some embodiments, multiple repetitions of a particular process block may be employed before proceeding to the next decision block or process block. In addition, although blocks 462-466 in FIG. 4D have been separately illustrated and described, in some embodiments, process blocks may be combined and performed together (simultaneously or sequentially). Moreover, although FIG. 4D illustrate a particular order for blocks 462-466, embodiments of the disclosed subject matter are not limited thereto. Indeed, in certain embodiments, the blocks may occur in a different order than illustrated or simultaneously with other blocks.

Referring to FIG. 4E, a method 470 for drying to form a densified structure is shown. For example, softened fibrous plant material can be prepared according to method 400 of FIG. 4A. The method 470 can proceed to process block 472, where the softened fibrous plant material can be subjected to drying, for example, such that the moisture content therein is less than 15 wt % (e.g., 3-10 wt %). In some embodiments, the drying can be such that the structures of the longitudinally-extending lumina in the microstructure of the softened fibrous plant material at least partially collapse, for example, due to surface-tension-induced collapse or crumpling from evaporation of water. For example, the drying can comprise an air drying process (e.g., drying in air for several hours, such as at least 24 hours). As a result, the fibrous plant material can self-densify, for example, to have a mechanical strength of at least 300 MPa.

The method 470 can proceed to optional process block 474, where the self-densified fibrous plant material can optionally be subjected to one or more modifications. In some embodiments, the optional modification can comprise sealing the densified fibrous plant material, for example, to prevent ingress of moisture or egress of moisture. For example, the sealing can be by placing the densified fibrous plant material in a sealed or controlled environment. Alternatively or additionally, the sealing can be achieved by a protective layer or coating provided over exposed surfaces of densified fibrous plant material. For example, the protecting layer or coating can be a polyurethane coating, paint, silane hydrophobic coating, or any other coating effective to prevent, or at least restrict, movement of moisture into or out of the densified fibrous plant material. Alternatively or additionally, the optional modification can include a destructive modification, for example, machining or cutting to prepare the densified fibrous plant material for subsequent use.

In some embodiments, the optional modification can include applying a coating to external surfaces and/or internal surfaces of the densified fibrous plant material, and/or coupling particles to the external surfaces and/or internal surfaces of the densified fibrous plant material. In some embodiments, the coating can have a thickness less than or equal to 10 μm, for example, in a range of 10 nm-10 μm, inclusive. In some embodiments, the coating or the coupled particles can include a conductive material, a semiconductive material, or an insulating material. For example, the coating or the coupled particles can include nanoparticles, nanowires, graphene, graphite, ceramic oxide, single-walled carbon nanotubes (CNTs), double-walled CNTs, multi-walled CNTs, polyaniline, carbon black, graphite, hard carbon (e.g., char or non-graphitizing carbon), reduced graphene oxide, graphene, plasmonic metallic nanoparticles, catalytic nanoparticles, electroactive nanoparticles, metal alloy nanoparticles, semiconductor nanoparticles, sulfides, phosphides, borides, oxides, or any combination of the foregoing. Examples of materials for the plasmonic metallic nanoparticles include but are not limited to Au. Pt, Ag, Pd, and Ru. The metallic nanoparticles and the metal alloy nanoparticles can include, but are not limited to, Pt, Pd, Au, Ag, Ni, Co, Ru, and Fe. Examples of materials for the semiconductor nanoparticles include CuFeSe₂ or any other semiconductor. Examples of materials for the sulfides include, but are not limited to, MOS₂, CoSₓ, and FeS₂, where x is an integer. Examples of materials for the phosphides include, but are not limited to, CoP, NiP₂, and MoPₓ, where x is an integer. Examples of materials for the borides include, but are not limited to. CoB, MoB, and NiB. Examples of materials for the oxides include, but are not limited to, MnO₂, Fe₂O₃, CoO, and NiO.

Alternatively or additionally, in some embodiments, the coating can comprise a hydrophobic material, a water-resistant material, a weather-resistant material, or any combination of the foregoing. For example, the coating can comprise manganese oxide polystyrene (MnO₃/PS) nano-composite, zinc oxide polystyrene (ZnO/PS) nano-composite, precipitated calcium carbonate, carbon nanotube structures, silica nano-coating, fluorinated silanes, polyethylene, polystyrene, polyvinylchloride, polytetrafluorethylene, polydimethylsiloxane, polyester, polyurethane, acrylic, epoxy, or any combination of the foregoing. Alternatively or additionally, the coating can comprise sodium chloride, potassium sulphate, sodium sulphate, calcium sulphate, magnesium sulphate, copper sulphate, sodium nitrate, sodium carbonate, calcium, silicon, phosphorus, silver, titanium oxide, or any combination of the foregoing.

The method 470 can proceed to process block 476, where the densified plant material can be used in a particular application. For example, the densified plant material can be adapted for use as structural material (e.g., a load bearing component or a non-load bearing component). For example, the densified plant material can have a mechanical strength (e.g., tensile strength) of at least 300 MPa. Other applications beyond those specifically listed are also possible for the densified plant material. Indeed, one of ordinary skill in the art will readily appreciate that the densified plant materials disclosed herein can be adapted to other applications based on the teachings of the present disclosure.

Although blocks 472-476 of method 470 have been described as being performed once, in some embodiments, multiple repetitions of a particular process block may be employed before proceeding to the next decision block or process block. In addition, although blocks 472-476 of method 470 have been separately illustrated and described, in some embodiments, process blocks may be combined and performed together (simultaneously or sequentially). Moreover, although FIG. 4E illustrates a particular order for blocks 472-476, embodiments of the disclosed subject matter are not limited thereto. Indeed, in certain embodiments, the blocks may occur in a different order than illustrated or simultaneously with other blocks.

### Heating Systems for Chemical Activation

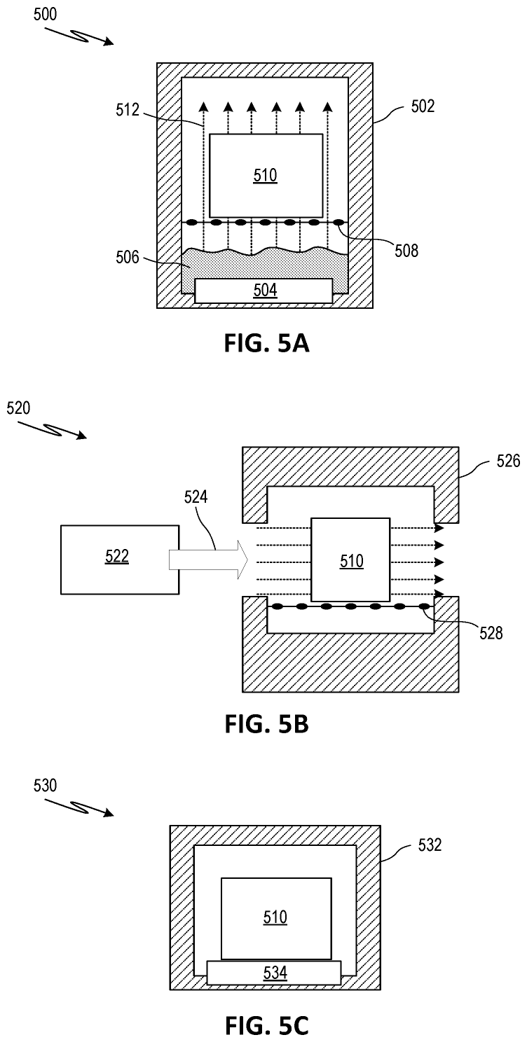

In some embodiments, the chemically-infiltrated fibrous plant material can be subjected to an elevated temperature (e.g., 80-180° C., such as 120-160° C.) by heating with steam, in order to react the infiltrated chemical with the native lignin and/or hemicellulose in the microstructure of the fibrous plant material, without adding of any additional chemical solutions. In some embodiments, the heating can be for at least 1 hour, for example, 1-5 hours, depending on the size of the fibrous plant material, with thicker pieces requiring longer heating times. In some embodiments, the steam heating can be performed in a pressure reactor, such as reactor 500 of FIG. 5A. In the illustrated example of FIG. 5A, the reactor 500 can have walls 502 that define an interior volume with a shelf 508 (e.g., porous or wire shelf) extending over a body of water 506. The shelf 508 can support the chemically-infiltrated fibrous plant material 510 over water 506, so as to receive steam 512 generated by heating of water 506 by heater element 504 (which may be internal to the reactor 500, external to the reactor 500, and/or integrated with wall 502 of the reactor 500). For example, the reactor 500 can have an interior volume of 2 L, and the body of water can have a volume of 50 mL of water.

Alternatively, in some embodiments, the steam heating can be performed using a flow-through reactor, such as reactor 520 of FIG. 5B. In the illustrated example of FIG. 5B, the reactor 520 can have walls 526 that define a flow-through volume with a support surface 528. The support surface 528 can support the chemically-infiltrated fibrous plant material 510 within the flow-through volume so as to receive steam 524 generated by a separate steam source 522 (e.g., a superheated steam generator).

Alternatively, in some embodiments, the heating can be performed without the use of steam, for example, using conductive and/or radiative heating. In some embodiments, the heating can be such that water loss from the chemically-infiltrated fibrous plant material is minimized, or at least reduced, for example, by performing the heating in a sealed pressure reactor, such as reactor 530 of FIG. 5C. In the illustrated example of FIG. 5C, the reactor 530 can have walls 532 that define a sealed interior volume, in which the chemically-infiltrated fibrous plant material can be placed in thermal contact with or proximal to heater 534 (which may be internal to the reactor 530, external to the reactor 530, and/or integrated with wall 532 of the reactor 530).

### Fabricated Examples and Experimental Results

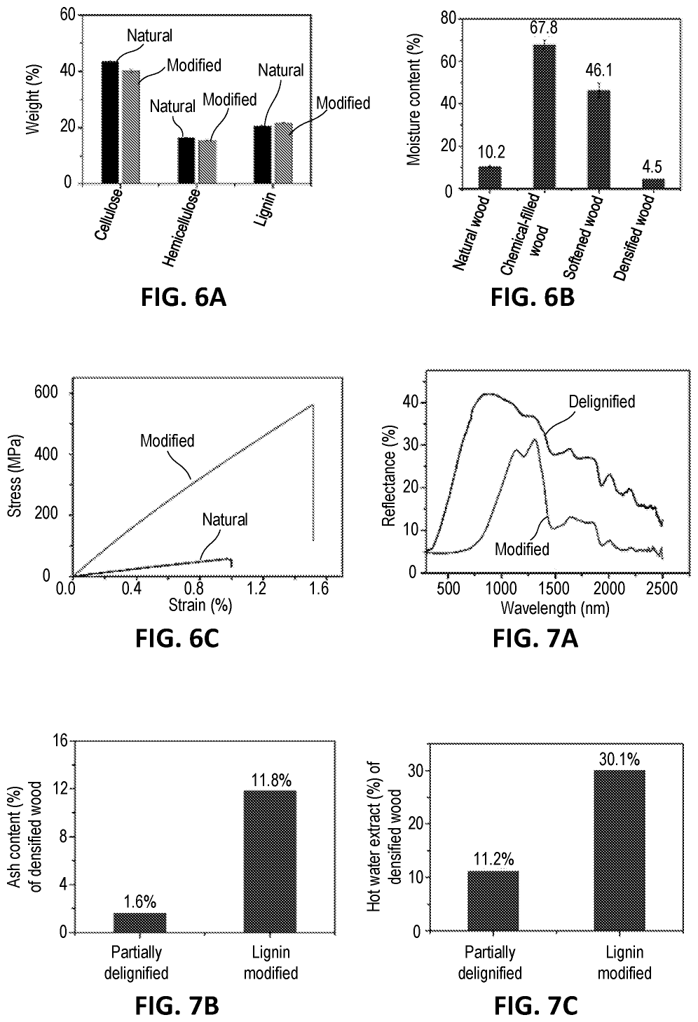

Softened wood was prepared by infiltrating a piece of basswood (20 cm×8 cm×2.5 cm) with 3% NaOH. In particular, the basswood was immersed in the 3% NaOH in a container, which was then placed in a vacuum box and subject to vacuum. Air in the wood is thus drawn out and forms a negative pressure within the microstructure. The negative pressure sucks the NaOH into the natural channels of the wood microstructure. The process was repeated three times at room temperature such that the channels were filled with the NaOH solution, which process took about 2 hours to complete. After this process, the moisture content can increase from ˜10.2% to close to 70%, as shown in FIG. 6B. The NaOH-infiltrated basswood was then heated using steam in a pressure reactor (e.g., reactor 500 of FIG. 5A), at a temperature of ˜160° C. for 3 hours. After the heating, the pressure relief valve of the reactor was opened, and the moisture in the wood was released from the vessel in the form of steam. After the pressure of the vessel drops to 0 psi from 90 psi, the vessel was opened, and the now softened wood (with modified lignin and hemicellulose retained therein) was removed. The moisture content of the resulting softened wood was ˜46%, as shown in FIG. 6B.

To measure chemical compositions of natural wood and softened wood, two wood samples (2.5 cm×2.5 cm×2.5 cm) were first oven-dried at 105° C. overnight. The resulting blocks were then ground using a 4-mesh outlet screen (˜5 mm). This was followed by a second pass using a 20-mesh (˜1 mm) screen. The resulting materials were first hydrolyzed using sulfuric acid in two stages. The hydrolysis conditions were an acid concentration of 72% (v/v) at 30° C. and 3.6% (v/v) at 120° C. for the first and second stages, respectively. The hydrolysis duration time was 1 hour for both stages. The hydrolysate was then analyzed for carbohydrates in an improved high-performance anion exchange chromatographic method using pulsed amperometric detection (HPAEC-PAD). The Klason lignin content was measured gravimetrically after washing and drying the solid residue from the acid hydrolysis. The results of the content measurements are shown in FIG. 6A, which confirms that the wt % content of each wood component before processing (e.g., in its native form) and after processing (e.g., in its modified form but immobilized within the wood) remains substantially the same.

To obtain densified wood, the softened basswood was subsequently compressed at a pressure of ˜5 MPa and a temperature of ˜120° C. for about ˜20 min to yield a densified wood with improved mechanical properties. For example, as shown in the mechanical test results of FIG. 6C (with tensile values being measured along a direction parallel to the longitudinal growth direction), the densified wood can have a mechanical strength of ˜560 MPa, which is much greater (e.g., ˜10×) than that of the natural wood.

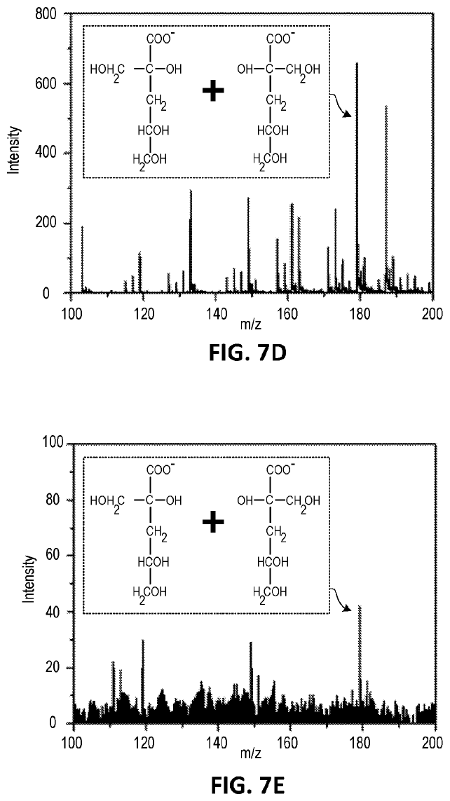

In addition, since the densified wood retains the lignin and hemicellulose of the natural wood as well as the neutralized salts from chemical reaction, the densified wood can have measurable physical differences as compared to densified wood obtained using conventional partial delignification techniques (e.g., immersion in 3% NaOH at 100° C., followed by rinsing, and densification). For example, the color of the densified wood with in situ lignin modification can be visually darker than that of the partially-delignified, densified wood. The reflectance of both wood samples was measured according to ASTM E903-20, entitled “Standard Test Method for Solar Absorptance, Reflectance, and Transmittance of Materials Using Integrating Spheres,” and published Oct. 21, 2020, which is incorporated herein by reference. As shown in FIG. 7A, the reflectance of the densified wood with in situ lignin modification is lower over the entire wavelength range as compared to the partially-delignified, densified wood. In particular, the densified wood with in situ lignin modification has a maximum reflectance in a first wavelength range of 500-2500 nm that is less than or equal to 35%. The densified wood with in situ lignin modification also has a reflectance over a second wavelength range of 500-1000 nm that is in a range of 0-20%.

To evaluate immobilized contents within the densified wood with in situ lignin modification as compared to partially-delignified, densified wood, the ash content (e.g., indicative of the inorganic content of the densified wood) and the hot water extract (e.g., indicative of components retained in the densified wood) were measured. The ash content (weight of ash as a percentage of the original weight of the densified wood) was measured according to ASTM D2584-18, entitled “Standard Test Method for Ignition Loss of Cured Reinforced Resins,” and published Oct. 8, 2018, ASTM D5630-13, entitled “Standard Test Method for Ash Content in Plastics,” and published Apr. 1, 2014, and ISO 3451-1:2019, entitled “Plastics—Determination of Ash—Part 1: General Methods,” and published February 2019, each of which is incorporated herein by reference. As shown in FIG. 7B, the densified wood with in situ lignin modification exhibits a substantially higher ash content (e.g., 11.8% versus 1.6%) than the partially-delignified, densified wood, due to the increase in salt content (e.g., sodium salts) resulting from the infiltrated chemicals and/or the lack of a rinsing step after the chemical treatment and prior to densification.

The hot water extract (weight of residue after evaporation of water as a percentage of the original weight of the densified wood) was measured according to ASTM D1110-84(2007), entitled “Standard Test Methods for Water Solubility of Wood,” and published Sep. 10, 2013, which is incorporated herein by reference. As shown in FIG. 7C, the densified wood with in situ lignin modification exhibits a substantially higher hot water extract (e.g., 30.1% versus 11.2%) than the partially-delignified, densified wood. Since there is no rinsing prior to densification, the degradation products of lignin, hemicellulose, and cellulose can be retained in the pores of the densified wood with in situ lignin modification, which degradation products (and salts formed thereby) can be subsequently measured via the hot water extract. In contrast, degradation products and/or salts are removed from the partially-delignified wood by rinsing prior to the densification.

In the in situ lignin modification process, the alkaline chemical (e.g., NaOH) primarily reacts with lignin, hemicellulose, and cellulose in the wood. Thus, the main products of the modification process are organic salts. To evaluate the chemical composition of these salts, the hot water extract solutions (e.g., as obtained for FIG. 7C) from partially-delignified, densified wood and densified wood with in situ lignin modification were subject to analysis via electrospray ionization mass spectrometry (ESI-MS). In particular, the hot water extract solution for each sample was prepared by soaking 3 g of the respective wood in powder form (e.g., via grinding) in 200 mL of water condensate reflux for 4 hours, after which the solution was introduced into the mass-spectrometer. FIG. 7D shows the mass spectra obtained for the densified wood with in situ lignin modification sample, and FIG. 7E shows the mass spectra obtained for the partially-delignified, densified wood sample. As shown in FIG. 7D, the in situ lignin modified sample exhibits substantially higher peaks corresponding to the retained organic salts (with the peak for sodium salts of gluconate identified in each figure) than the partially-delignified sample in FIG. 7E.

To avoid production of wastewater (e.g., fluid containing degradation products and/or chemicals from the lignin modification, as opposed to substantially clean fluid vapor that evaporates during drying) during the densification process, some of the moisture in the softened wood after the in situ lignin modification can be removed prior to densification. In another fabricated example, a piece of basswood (10 cm×5 cm×0.5 cm) was infiltrated with 3% NaOH in a manner similar to that described above. The resulting chemical-infiltrated wood had a moisture content of 75 wt %. The chemical-infiltrated wood was then heated using steaming in a manner similar to that described above to yield softened wood. In particular, after the steam heating is completed, the pressure in the reactor was vented, thereby removing ˜50% of the moisture in the sample, such that softened wood has a moisture content of 34.5 wt %. Note that the smaller size of the wood sample allowed more moisture to be introduced during the chemical infiltration step and more moisture to be removed during the steam heating step as compared to the processing of the wood sample of FIG. 6B. To remove additional moisture prior to densification, the softened wood was pre-dried in ambient air until it had a moisture content of ˜15 wt %. The pre-dried wood was then subjecting to densification via pressing. The final densified wood with in situ lignin modification had a moisture content of ˜5.7 wt %. During and after the densification, no liquid water was produced from the wood sample.

Softened bamboo was prepared by infiltrating a piece of bamboo with 4% NaOH. The NaOH-infiltrated bamboo was then heated using steam in a pressure reactor (e.g., reactor 500 of FIG. 5A), at a temperature of ˜160° C. for 1 hour. After the heating, the pressure relief valve of the reactor was opened, and the moisture in the bamboo was released from the vessel in the form of steam. To obtain densified bamboo, the softened bamboo was subsequently compressed in two stages. During a first stage, the softened bamboo was first pressed at a pressure of ˜1 MPa and a temperature of ˜66° C. for ˜5 min. During a second stage, the softened bamboo was further pressed at a pressure of ˜5 MPa and a temperature of ˜120° C. for ˜20 min to yield a densified bamboo with improved mechanical properties. For example, as shown in the mechanical test results of FIG. 7 (with tensile values being measured along a direction parallel to the longitudinal growth direction), the densified bamboo can have a mechanical strength of ˜510 MPa (e.g., 511.4±13.5 MPa), which is much greater than that of the natural bamboo. The thickness of the densified bamboo was about 50% of that of the original bamboo piece.

Self-densified wood was prepared by infiltrating a piece of basswood with 3% NaOH. The NaOH-infiltrated basswood was then heated using steam in a pressure reactor (e.g., reactor 500 of FIG. 5A), at a temperature of ˜160° C. for 1 hour. After the heating, the pressure relief valve of the reactor was opened, and the moisture in the basswood was released from the vessel in the form of steam. To obtain self-densified basswood, the softened basswood was allowed to dry in air at room temperature for 24 hours, which resulted in a partially collapsed microstructure having improved mechanical properties. In particular, after the drying, the self-densified basswood had a density of ˜1.05 g/cm³, whereas the original natural basswood had a density of ˜0.4 g/cm³. As shown in the mechanical test results of FIG. 8 (with tensile values being measured along a direction parallel to the longitudinal growth direction), the self-densified basswood can have a mechanical strength of ˜300 MPa (e.g., 303.7±10.1 MPa), which is still much greater than that of the natural basswood.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A method comprising:
(a) infiltrating a piece of natural fibrous plant material with one or more chemical solutions; and
(b) after (a), subjecting the piece of natural fibrous plant material with the one or more chemical solutions therein to a first temperature of at least 80° C. for a first time so as to produce a softened piece of fibrous plant material,
wherein a content of modified lignin in the softened piece after (b) is at least 90% of a content of native lignin in the piece of natural fibrous plant material prior to (a), and
the modified lignin retained in the softened piece after (b) has shorter macromolecular chains than that of the native lignin in the fibrous plant material prior to (a).
   Clause 2. The method of any clause or example herein, in particular Clause 1, wherein a content of modified hemicellulose in the softened piece after (b) is at least 90% of a content of native hemicellulose in the piece of natural fibrous plant material prior to (a).
   Clause 3. The method of any clause or example herein, in particular, any one of Clauses 1-3, wherein, after (b), the softened piece of fibrous plant material comprises a salt of the one or more chemical solutions.
   Clause 4. The method of any clause or example herein, in particular, Clause 3, wherein the salt is a substantially pH-neutral salt immobilized within the softened piece of fibrous plant material.
   Clause 5. The method of any clause or example herein, in particular, any one of Clauses 3-4, wherein the salt is formed by reaction of the one or more chemical solutions with an acidic degradation product of native hemicellulose in the piece of natural fibrous plant material produced by the one or more chemical solutions during (b).
   Clause 6. The method of any clause or example herein, in particular, any one of Clauses 1-5, wherein the one or more chemical solutions comprises an alkaline solution.
   Clause 7. The method of any clause or example herein, in particular, any one of Clauses 1-6, wherein the one or more chemical solutions comprises p-toluenesulfonic acid, NaOH, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing.
   Clause 8. The method of any clause or example herein, in particular, any one of Clauses 1-7, wherein the first temperature is in a range of 80-180° C., inclusive.
   Clause 9. The method of any clause or example herein, in particular, any one of Clauses 1-8, wherein the first temperature is in a range of 120-160° C., inclusive.
   Clause 10. The method of any clause or example herein, in particular, any one of Clauses 1-9, wherein the one or more chemical solutions infiltrated in the piece of natural fibrous material are consumed during (b).
   Clause 11. The method of any clause or example herein, in particular, any one of Clauses 1-10, wherein at least 90% of the one or more chemical solutions infiltrated in the piece of natural fibrous material is consumed during (b).
   Clause 12. The method of any clause or example herein, in particular, any one of Clauses 1-11, wherein the softened piece of fibrous plant material after (b) has a substantially neutral pH.
   Clause 13. The method of any clause or example herein, in particular, any one of Clauses 1-12, wherein the first time is at least 1 hour.
   Clause 14. The method of any clause or example herein, in particular, any one of Clauses 1-13, wherein the first time is in a range of 1-5 hours, inclusive.
   Clause 15. The method of any clause or example herein, in particular, any one of Clauses 1-14, wherein:
a first moisture content of the piece of natural fibrous plant material prior to (a) is less than a second moisture content of the piece of natural fibrous plant material with the one or more chemical solutions therein after (a); and
a third moisture content of the softened piece of fibrous plant material after (b) is between the first and second moisture contents.
   Clause 16. The method of any clause or example herein, in particular, Clause 15, wherein:
the first moisture content is less than 20 wt %;
the second moisture content is greater than 50 wt %;
the third moisture content is less than 50 wt %; or
any combination of the above.
   Clause 17. The method of any clause or example herein, in particular, any one of Clauses 1-16, wherein the subjecting to the first temperature of (b) comprises using steam to heat the piece of natural fibrous plant material with the one or more chemical solutions therein.
   Clause 18. The method of any clause or example herein, in particular, Clause 17, wherein the heating using steam is performed with the piece of natural fibrous plant material, with the one or more chemical solutions therein, in a pressure reactor or in a flow-through steam reactor.
   Clause 19. The method of any clause or example herein, in particular, any one of Clauses 1-18, further comprising, after (b):
(c) compressing the softened piece of fibrous plant material to produce a densified piece of fibrous plant material,
wherein the densified piece of fibrous plant material after (c) has a first density greater than a second density of the piece of natural fibrous plant material prior to (a).
   Clause 20. The method of any clause or example herein, in particular, any one of Clauses 1-18, wherein (b) comprises compressing the softened piece of fibrous plant material while simultaneously subjecting to the first temperature, so as to produce a densified piece of fibrous plant material, and the densified piece of fibrous plant material after (c) has a first density greater than a second density of the piece of natural fibrous plant material prior to (a).
   Clause 21. The method of any clause or example herein, in particular, any one of Clauses 19-20, wherein the first density is at least 1.15 g/cm³.
   Clause 22. The method of any clause or example herein, in particular, any one of Clauses 19-21, wherein the first density is at least 1.2 g/cm³.
   Clause 23. The method of any clause or example herein, in particular, any one of Clauses 19-22, wherein the first density is at least 1.3 g/cm³.
   Clause 24. The method of any clause or example herein, in particular, any one of Clauses 19-23, wherein the second density is less than 1.0 g/cm³.
   Clause 25. The method of any clause or example herein, in particular, any one of Clauses 19-24, wherein the compressing is in a direction crossing a longitudinal growth direction of the softened piece of fibrous plant material.
   Clause 26. The method of any clause or example herein, in particular, any one of Clauses 19-25, wherein the softened piece of fibrous plant material prior to (c) has a first thickness along a direction substantially perpendicular to the longitudinal growth direction that is at least two times a second thickness along a direction substantially perpendicular to the longitudinal growth direction of the densified piece of fibrous plant material.
   Clause 27. The method of any clause or example herein, in particular, Clause 26, wherein the first thickness is between three and five, inclusive, times the second thickness.
   Clause 28. The method of any clause or example herein, in particular, any one of Clauses 19-27, wherein the densified piece of fibrous plant material after (c) has a maximum reflectance in a first wavelength range of 500 nm to 2500 nm, inclusive, that is less than or equal to 35%.
   Clause 29. The method of any clause or example herein, in particular, any one of Clauses 19-28, wherein a reflectance of the densified piece of fibrous plant material after (c) over a second wavelength range of 500 nm to 1000 nm, inclusive, is in a range of 0-20%, inclusive.
   Clause 30. The method of any clause or example herein, in particular, any one of Clauses 19-29, wherein the densified piece of fibrous plant material after (c) has a strength of at least 500 MPa.
   Clause 31. The method of any clause or example herein, in particular, any one of Clauses 19-30, wherein the compressing comprises pressing the softened piece of fibrous plant material at pressure of at least 5 MPa.
   Clause 32. The method of any clause or example herein, in particular, any one of Clauses 19-31, wherein the compressing comprises pressing the softened piece of fibrous plant material at a pressure in a range of 5-20 MPa, inclusive.
   Clause 33. The method of any clause or example herein, in particular, any one of Clauses 19-32, wherein the compressing comprises pressing the softened piece of fibrous plant material while subjecting to a second temperature of at least 80° C.
   Clause 34. The method of any clause or example herein, in particular, Clause 33, wherein the second temperature is in a range of 80-180° C., inclusive.
   Clause 35. The method of any clause or example herein, in particular, any one of Clauses 33-34, wherein the second temperature is in a range of 100-160° C., inclusive.
   Clause 36. The method of any clause or example herein, in particular, any one of Clauses 19-35, wherein the compressing comprises:
pressing the softened piece of fibrous plant material at a first pressure for a second time, followed by further pressing at a second pressure for a third time,
wherein (i) the second pressure is greater than the first pressure, (ii) the third time is greater than the second time, or both (i) and (ii).
   Clause 37. The method of any clause or example herein, in particular, Clause 36, wherein the pressing at the first pressure for the second time is performed while subjecting the softened piece to a first pressing temperature, and/or the pressing at the second pressure for the third time is performed while subjecting the softened piece to a second pressing temperature greater than the first pressing temperature.
   Clause 38. The method of any clause or example herein, in particular, Clause 37, wherein:
the first pressure is less than or equal to about 1 MPa;
the second pressure is greater than or equal to about 5 MPa;
the first time is less than or equal to about 5 minutes;
the second time is greater than or equal to about 20 minutes;
the first pressing temperature is less than or equal to about 65° C.;
the second pressing temperature is greater than or equal to about 120° C.; or any combination of the above.
   Clause 39. The method of any clause or example herein, in particular, any one of Clauses 19-38, wherein a first moisture content of the piece of natural fibrous plant material prior to (a) is greater than a fourth moisture content of the densified piece of fibrous plant material after (c).
   Clause 40. The method of any clause or example herein, in particular, Clause 39, wherein:
the first moisture content is in a range of 10-20 wt %, inclusive;
the fourth moisture content is less than 10 wt %; or both of the above.

Clause 41. The method of any clause or example herein, in particular, any one of Clauses 19-40, wherein:
a content of the modified lignin in the densified piece after (c) is at least 90% of the content of the native lignin in the piece of natural fibrous plant material prior to (a);
a content of modified hemicellulose in the densified piece after (c) is at least 90% of the content of native hemicellulose in the piece of natural fibrous plant material prior to (a); or
both of the above.
   Clause 42. The method of any clause or example herein, in particular, any one of Clauses 19-41, wherein, after (c), the densified piece of fibrous plant material comprises a salt of the one or more chemical solutions.
   Clause 43. The method of any clause or example herein, in particular, any one of Clauses 19-42, wherein the densified piece of fibrous plant material after (c) has a substantially neutral pH.
   Clause 44. The method of any clause or example herein, in particular, any one of Clauses 19-43, wherein the densified piece of fibrous plant material is formed without any rinsing to remove the one or more chemical solutions prior to (c).
   Clause 45. The method of any clause or example herein, in particular, any one of Clauses 1-18, further comprising, after (b):
drying the softened piece of fibrous plant material such that lumina in a native microstructure of the natural fibrous plant material collapse so as to form a self-densified piece of fibrous plant material,
wherein the self-densified piece of fibrous plant material has a third density greater than a second density of the piece of natural fibrous plant material prior to (a).
   Clause 46. The method of any clause or example herein, in particular, Clause 45, wherein the drying comprises drying in air and/or at room temperature.
   Clause 47. The method of any clause or example herein, in particular, any one of Clauses 45-46, wherein the third density is greater than 1.0 g/cm³ and/or the second density is less than 0.5 g/cm³.
   Clause 48. The method of any clause or example herein, in particular, any one of Clauses 45-47, wherein the self-densified piece of fibrous plant material has a strength greater than 300 MPa.
   Clause 49. The method of any clause or example herein, in particular, any one of Clauses 1-18, further comprising, after (b), drying the softened piece of fibrous plant material so as to form a dried piece that retains open lumina of a native microstructure of the natural fibrous plant material.
   Clause 50. The method of any clause or example herein, in particular, Clause 49, wherein the drying comprises freeze-drying, critical point drying, solvent exchange, or any combination of the foregoing.
   Clause 51. The method of any clause or example herein, in particular, any one of Clauses 49-50, wherein the dried piece is substantially elastic along a direction perpendicular to a longitudinal growth direction of the fibrous plant material and substantially inelastic along a direction parallel to the longitudinal growth direction.
   Clause 52. The method of any clause or example herein, in particular, any one of Clauses 1-18, further comprising, after (b):
(d) drying the softened piece of fibrous plant material so as to remove moisture therefrom, such that lumina of at least some of cellulose-based longitudinal cells of the fibrous plant material collapse and such that the dried piece has a moisture content less than or equal to 15 wt %;
(e) performing a fluid-shock treatment to the dried piece to yield a rehydrated piece of fibrous plant material, the fluid-shock treatment comprising exposing the dried piece to moisture, the rehydrated piece having a moisture content of at least 35 wt %; and
(f) molding the rehydrated piece of fibrous plant material from a substantially flat planar configuration into a non-planar three-dimensional configuration.
   Clause 53. The method of any clause or example herein, in particular, any one of Clauses 1-18, further comprising, after (b):
partially-drying the softened piece of fibrous plant material so as to remove some moisture therefrom, the partially-dried piece of fibrous plant material having a moisture content of at least 35%; and
molding the partially-dried piece of fibrous plant material from a substantially flat planar configuration into a non-planar three-dimensional configuration.
   Clause 54. The method of any clause or example herein, in particular, any one of Clauses 52-53, wherein the moisture content of the rehydrated piece during (f) is at least 50 wt %.
   Clause 55. The method of any clause or example herein, in particular, any one of Clauses 52-54, further comprising, after (f):
(g) drying the molded piece of fibrous plant material to remove moisture therefrom, so as to set a shape of the piece and form a rigid monolithic piece of fibrous plant material in the non-planar three-dimensional configuration,
wherein the rigid monolithic piece has a moisture content less than or equal to 15 wt %.
   Clause 56. The method of any clause or example herein, in particular, any one of Clauses 52-55, wherein the drying of (g) comprises exposing to an air or gas flow, exposing to a stagnant volume of air or gas, exposing to vacuum, exposing to room temperature, heating to a temperature above room temperature, or any combination of the foregoing.
   Clause 57. The method of any clause or example herein, in particular, any one of Clauses 1-56, wherein the piece of natural fibrous plant material prior to (a) has a native microstructure of open lumina formed by cellulose-based cell walls, and the softened piece produced by (b) retains the open lumina formed by the cellulose-based cell walls.
   Clause 58. The method of any clause or example herein, in particular, any one of Clauses 1-57, wherein the natural fibrous plant material is wood, bamboo, reed, or grass.
   Clause 59. The method of any clause or example herein, in particular, any one of Clauses 1-58, wherein (a) and (b) are performed without producing black liquor or other waste liquid.
   Clause 60. A softened piece of fibrous plant material formed by the method of any clause or example herein, in particular, any one of Clauses 1-59.
   Clause 61. A densified piece of fibrous plant material formed by the method of any clause or example herein, in particular, any one of Clauses 1-59.
   Clause 62. A dried or molded piece of fibrous plant material formed by the method any clause or example herein, in particular, any one of Clauses 49-59.
   Clause 63. A structure comprising:
a densified piece of fibrous plant material having a density of at least 1.0 g/cm³ and modified lignin therein,
wherein the modified lignin has shorter macromolecular chains than that of native lignin in natural fibrous plant material.
   Clause 64. The structure of any clause or example herein, in particular, Clause 63, wherein a content of modified lignin in the densified piece of fibrous plant material is at least 90% of a content of the native lignin in the natural fibrous plant material.
   Clause 65. The structure of any clause or example herein, in particular, any one of Clauses 63-64, wherein a content of modified lignin in the densified piece of fibrous plant material is at least 20 wt %.
   Clause 66. The structure of any clause or example herein, in particular, any one of Clauses 63-65, wherein a content of modified hemicellulose in the densified piece of fibrous plant material is at least 90% of a content of native hemicellulose in the natural fibrous plant material.
   Clause 67. The structure of any clause or example herein, in particular, any one of Clauses 63-66, wherein a content of modified hemicellulose in the densified piece of fibrous plant material is at least 15 wt %.
   Clause 68. The structure of any clause or example herein, in particular, any one of Clauses 63-67, wherein the density of the densified piece of fibrous plant material is at least 1.15 g/cm³.
   Clause 69. The structure of any clause or example herein, in particular, any one of Clauses 63-68, wherein the density of the densified piece of fibrous plant material is at least 1.2 g/cm³.
   Clause 70. The structure of any clause or example herein, in particular, any one of Clauses 63-69, wherein the density of the densified piece of fibrous plant material is at least 1.3 g/cm³.
   Clause 71. The structure of any clause or example herein, in particular, any one of Clauses 63-70, wherein a density of the natural fibrous plant material is less than 1.0 g/cm³.
   Clause 72. The structure of any clause or example herein, in particular, any one of Clauses 63-71, wherein the densified piece of fibrous plant material comprises or has a salt of an alkaline chemical immobilized within a microstructure fibrous plant material.
   Clause 73. The structure of any clause or example herein, in particular, Clause 72, wherein the salt is substantially pH-neutral.
   Clause 74. The structure of any clause or example herein, in particular, any one of Clauses 63-73, wherein the densified piece of fibrous plant material has a moisture content less than 10 wt %.
   Clause 75. The structure of any clause or example herein, in particular, any one of Clauses 63-74, wherein the densified piece of fibrous plant material has been compressed in a direction substantially perpendicular to a longitudinal growth direction of the fibrous plant material, such that lumina formed by cellulose-based cell walls in a microstructure of the fibrous plant material have substantially collapsed.
   Clause 76. The structure of any clause or example herein, in particular, any one of Clauses 63-75, wherein:
the densified piece of fibrous plant material has a maximum reflectance in a first wavelength range of 500-2500 nm, inclusive, that is less than or equal to 35%;
the densified piece of fibrous plant material has a reflectance over a second wavelength range of 500-1000 nm, inclusive, that is in a range of 0-20%, inclusive; or
both of the above.
   Clause 77. The structure of any clause or example herein, in particular, any one of Clauses 63-76, wherein the densified piece of fibrous plant material has a strength of at least 500 MPa.
   Clause 78. The structure of any clause or example herein, in particular, any one of Clauses 63-67 and 71-74, wherein the densified piece of fibrous plant material is formed by self-densification induced by air-drying and has a strength of at least 300 MPa.
   Clause 79. The structure of any clause or example herein, in particular, Clause 78, wherein the densified piece of fibrous plant material has a density greater than 1.0 g/cm³, and the natural fibrous plant material has a density less than 0.5 g/cm³.
   Clause 80. The structure of any clause or example herein, in particular, any one of Clauses 63-79, wherein the densified piece has a non-planar three dimensional configuration.
   Clause 81. A structure comprising:
a dried piece of fibrous plant material having modified lignin therein and retaining open lumina of a native microstructure of natural fibrous plant material,
wherein the modified lignin has shorter macromolecular chains than that of native lignin in the natural fibrous plant material.
   Clause 82. The structure of any clause or example herein, in particular, Clause 81, wherein a content of the modified lignin in the dried piece of fibrous plant material is at least 90% of a content of native lignin in the natural fibrous plant material.
   Clause 83. The structure of any clause or example herein, in particular, any one of Clauses 81-82, wherein a content of the modified lignin in the dried piece of fibrous plant material is at least 20 wt %.
   Clause 84. The structure of any clause or example herein, in particular, any one of Clauses 81-83, wherein a content of modified hemicellulose in the dried piece of fibrous plant material is at least 90% of a content of native hemicellulose in the natural fibrous plant material.
   Clause 85. The structure of any clause or example herein, in particular, any one of Clauses 81-84, wherein a content of modified hemicellulose in the dried piece of fibrous plant material is at least 15 wt %.
   Clause 86. The structure of any clause or example herein, in particular, any one of Clauses 81-85, wherein the dried piece of fibrous plant material is substantially elastic along a direction perpendicular to a longitudinal growth direction of the fibrous plant material and substantially inelastic along a direction parallel to the longitudinal growth direction.
   Clause 87. The structure of any clause or example herein, in particular any one of Clauses 63-86, wherein the densified piece or the dried piece consists essentially of the fibrous plant material.
   Clause 88. The structure of any clause or example herein, in particular any one of Clauses 63-87, wherein the densified piece or the dried piece comprises non-native particles deposited or formed on internal surfaces thereof, external surfaces thereof, or both.
   Clause 89. The structure of any clause or example herein, in particular Clause 88, wherein the non-native particles comprise hydrophobic nanoparticles.
   Clause 90. The structure of any clause or example herein, in particular any one of Clauses 63-89, further comprising a hydrophobic paint, a polymer coating, and/or a fire-resistant coating on one or more external surfaces of the densified piece or the dried piece.
   Clause 91. The structure of any clause or example herein, in particular Clause 90, wherein the first resistant coating comprises boron nitride, montmorillonite clay, hydrotalcite, silicon dioxide (SiO₂), sodium silicate, calcium carbonate (CaCO₃), aluminum hydroxide (Al(OH)₃), magnesium hydroxide (Mg(OH)₂), magnesium carbonate (MgCO₃), aluminum sulfate, iron sulfate, zinc borate, boric acid, borax, triphenyl phosphate (TPP), melamine, polyurethane, ammonium polyphosphate, phosphate, phosphite ester, ammonium phosphate, ammonium sulfate, phosphonate, diammonium phosphate (DAP), ammonium dihydrogen phosphate, monoammonium phosphate (MAP), guanylurea phosphate (GUP), guanidine dihydrogen phosphate, antimony pentoxide, or any combination of the foregoing.
   Clause 92. The structure of any clause or example herein, in particular any one of Clauses 63-91, wherein the densified piece or the dried piece has been subjected to a hydrophobic chemical treatment, a chemical treatment for resistance to weather or salt water, or both.
   Clause 93. The structure of any clause or example herein, in particular Clause 92, wherein: (1) the hydrophobic chemical treatment comprises epoxy resin, silicone oil, polyurethane, paraffin emulsion, acetic anhydride, octadecyltrichloro silane (OTS), 1H, 1H, 2H, 2H-perfluorodecyltriethoxysilane, fluororesin, polydimethylsiloxane (PDMS), methacryloxymethyltrimethyl-silane (MSi), polyhedral oligomeric silsesquioxane (POSS), potassium methyl siliconate (PMS), dodecyl(trimethoxy) silane (DTMS), hexamethyldisiloxane, dimethyl diethoxy silane, tetraethoxysilane, methyltrichlorosilane, ethyltrimethoxysilane, methyl triethoxysilane, trimethylchlorosilane, phenyltrimethoxysilane, phenyltriethoxysilane, propyltrimethoxysilane, polymethyl methacrylate, polydiallyldimethylammonium chloride (polyDADMAC), 3-(trimethoxysilyl)propyl methacrylate (MPS, hydrophobic stearic acid, amphiphilic fluorinated triblock azide copolymers, polyvinylidene fluoride and fluorinated silane, n-dodecyltrimethoxysilane, sodium lauryl sulfate, or any combination of the foregoing; and (2) the chemical treatment for resistance to weather or salt water comprises cupramate (CDDC), ammoniacal copper quaternary (ACQ), chromated copper arsenate (CCA), ammoniacal copper zinc arsenate (ACZA), copper naphthenate, acid copper chromate, copper citrate, copper azole, copper 8-hydroxyquinolinate, pentachlorophenol, zinc naphthenate, copper naphthenate, creosote, titanium dioxide, propiconazole, tebuconazole, cyproconazole, boric acid, borax, organic iodide (IPBC), Na₂B₈O₁₃·4H₂O, or any combination of the foregoing.
   Clause 94. The structure of any clause or example herein, in particular any one of Clauses 61-80 and 87-93, wherein the densified piece of fibrous plant material has an ash content of at least 5%, an ash content of at least 10%, a hot water extract of at least 15%, a hot water extract of at least 20%, a hot water extract of at least 25%, a hot water extract of at least 30%, or any combination of the foregoing.
   Clause 95. The structure of any clause or example herein, in particular, any one of Clauses 63-94, wherein the natural fibrous plant material is wood, bamboo, reed, or grass.
   Clause 96. The method of any clause or example herein, in particular, any one of Clauses 19-44, further comprising, after (b) and prior to (c), subjecting the softened piece of fibrous plant material to a pre-drying process such that the moisture content of the softened piece is in a range of 8-30 wt %, inclusive, or a range of 8-20 wt %, inclusive, or a range of 10-20 wt %, inclusive, or any combination of the foregoing.
   Clause 97. The method of any clause or example herein, in particular, Clause 96, wherein (i) the pre-drying process reduces the moisture content of the fibrous plant material from greater than 30 wt %, (ii) the pre-drying process reduces the moisture content of the fibrous plant material to about ˜15 wt %, or both (i) and (ii).
   Clause 98. The method of any clause or example herein, in particular, any one of Clauses 96-97, wherein after the pre-drying, the compressing of (c) produces substantially no water from the fibrous plant material.

### CONCLUSION

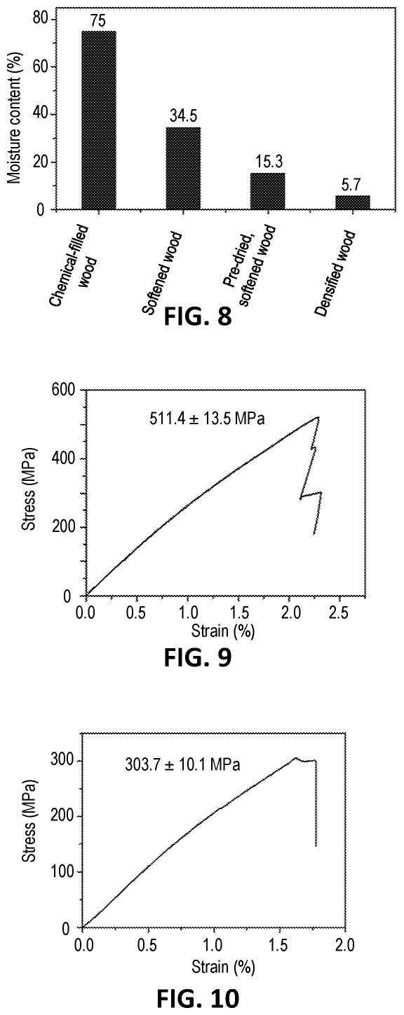

Any of the features illustrated or described herein, for example, with respect to FIGS. 1-10 and Clauses 1-98, can be combined with any other feature illustrated or described herein, for example, with respect to FIGS. 1-10 and Clauses 1-98 to provide materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A method comprising:
(a) infiltrating a piece of natural fibrous plant material with one or more chemical solutions; and
(b) after (a), subjecting the piece of natural fibrous plant material with the one or more chemical solutions therein to a first temperature of at least 80° C. for a first time so as to produce a softened piece of fibrous plant material,
wherein a content of modified lignin in the softened piece after (b) is at least 90% of a content of native lignin in the piece of natural fibrous plant material prior to (a),
the modified lignin retained in the softened piece after (b) has shorter macromolecular chains than that of the native lignin in the fibrous plant material prior to (a), and
after (b), the softened piece of fibrous plant material comprises a salt of the one or more chemical solutions.

2. The method of claim 1, wherein a content of modified hemicellulose in the softened piece after (b) is at least 90% of a content of native hemicellulose in the piece of natural fibrous plant material prior to (a).

3. (canceled)

4. The method of claim 1, wherein the salt is a substantially pH-neutral salt immobilized within the softened piece of fibrous plant material.

5. The method of claim 1, wherein the salt is formed by reaction of the one or more chemical solutions with an acidic degradation product of native hemicellulose in the piece of natural fibrous plant material produced by the one or more chemical solutions during (b).

6-7. (canceled)

8. The method of claim 1, wherein the first temperature is in a range of 80-180° C., inclusive.

9-10. (canceled)

11. The method of claim 1, wherein at least 90% of the one or more chemical solutions infiltrated in the piece of natural fibrous material is consumed during (b).

12. The method of claim 1, wherein the softened piece of fibrous plant material after (b) has a substantially neutral pH.

13-17. (canceled)

18. The method of claim 1, wherein:
the subjecting to the first temperature of (b) comprises using steam to heat the piece of natural fibrous plant material with the one or more chemical solutions therein; and
the heating using steam is performed with the piece of natural fibrous plant material, with the one or more chemical solutions therein, in a pressure reactor or in a flow-through steam reactor.

19. The method of claim 1, further comprising, after (b):
(c) compressing the softened piece of fibrous plant material to produce a densified piece of fibrous plant material,
wherein the densified piece of fibrous plant material after (c) has a first density greater than a second density of the piece of natural fibrous plant material prior to (a), the first density is at least 1.15 g/cm³, and the second density is less than 1.0 g/cm³.

20-34. (canceled)

35. The method of claim 19, wherein the compressing comprises:
pressing the softened piece of fibrous plant material at a first pressure for a second time, followed by further pressing at a second pressure for a third time,
wherein (i) the second pressure is greater than the first pressure, (ii) the third time is greater than the second time, or both (i) and (ii),
the pressing at the first pressure for the second time is performed while subjecting the softened piece to a first pressing temperature, and
the pressing at the second pressure for the third time is performed while subjecting the softened piece to a second pressing temperature greater than the first pressing temperature.

36-48. (canceled)

49. The method of claim 1, further comprising, after (b):
drying the softened piece of fibrous plant material so as to form a dried piece that retains open lumina of a native microstructure of the natural fibrous plant material,
wherein the drying comprises freeze-drying, critical point drying, solvent exchange, or any combination of the foregoing.

50-56. (canceled)

57. The method of claim 1, wherein the piece of natural fibrous plant material prior to (a) has a native microstructure of open lumina formed by cellulose-based cell walls, and the softened piece produced by (b) retains the open lumina formed by the cellulose-based cell walls.

58. (canceled)

59. The method of claim 1, wherein (a) and (b) are performed without producing black liquor or other waste liquid.

60-62. (canceled)

63. A structure comprising:
a densified piece of fibrous plant material having a density of at least 1.0 g/cm³ and modified lignin therein,
wherein the modified lignin has shorter macromolecular chains than that of native lignin in natural fibrous plant material, and
the densified piece of fibrous plant material comprises a salt of an alkaline chemical immobilized within a microstructure fibrous plant material.

64. The structure of claim 63, wherein a content of modified lignin in the densified piece of fibrous plant material is at least 90% of a content of the native lignin in the natural fibrous plant material.

65. (canceled)

66. The structure of claim 63, wherein a content of modified hemicellulose in the densified piece of fibrous plant material is at least 90% of a content of native hemicellulose in the natural fibrous plant material.

67-72. (canceled)

73. The structure of claim 63, wherein the salt is substantially pH-neutral.

74. (canceled)

75. The structure of claim 63, wherein the densified piece of fibrous plant material has been compressed in a direction substantially perpendicular to a longitudinal growth direction of the fibrous plant material, such that lumina formed by cellulose-based cell walls in a microstructure of the fibrous plant material have substantially collapsed.

76-80. (canceled)

81. A structure comprising:
a dried piece of fibrous plant material having modified lignin therein and retaining open lumina of a native microstructure of natural fibrous plant material,
wherein the modified lignin has shorter macromolecular chains than that of native lignin in the natural fibrous plant material, and
a content of modified hemicellulose in the dried piece of fibrous plant material is at least 90% of a content of native hemicellulose in the natural fibrous plant material.

82. The structure of claim 81, wherein a content of the modified lignin in the dried piece of fibrous plant material is at least 90% of a content of native lignin in the natural fibrous plant material.

83-87. (canceled)
